(19) United States
(12) Patent Application Publication
(10) Pub. No.: US 2014/0295252 A1
(43) Pub. Date: Oct. 2, 2014

(54) ELECTRODE TERMINAL CONNECTION BODY AND MANUFACTURING METHOD OF THE SAME

(71) Applicant: Hitachi Metals, Ltd., Tokyo (JP)

(72) Inventors: Toshiyuki Horikoshi, Mito (JP); Kotaro Tanaka, Naka-gun (JP); Takumi Sato, Hitachi (JP); Kenichi Murakami, Hitachi (JP)

(73) Assignee: Hitachi Metals, Ltd., Tokyo (JP)

(21) Appl. No.: 14/205,055

(22) Filed: Mar. 11, 2014

(30) Foreign Application Priority Data
Mar. 26, 2013 (JP) 2013-064041
Mar. 26, 2013 (JP) 2013-064042
Mar. 26, 2013 (JP) 2013-064043

(51) Int. Cl. H01M 2/20

(52) U.S. Cl. CPC H01M 2/202
USPC 429/161; 29/874

(57) ABSTRACT

An electrode terminal connection body, which is configured to electrically connect a positive electrode terminal and a negative electrode terminal that are formed of mutually different kinds of metals, includes a positive electrode terminal connection part formed of the same kind of metal as a metal of the positive electrode terminal, and a negative electrode terminal connection part formed of the same kind of metal as a metal of the negative electrode terminal. The positive electrode terminal connection part and the negative electrode terminal connection part are connected via an interposing part formed of a metal that has an ionization tendency between the metal of the positive electrode terminal and the metal of the negative electrode terminal.

The present application is based on Japanese patent applications Nos. 2013-064041, 2013-064042 and 2013-064043 filed on Mar. 26, 2013, the entire contents of which are incorporated herein by reference.

### BACKGROUND OF THE INVENTION

1. Field of the Invention

This invention relates to an electrode terminal connection body configured to electrically connect a positive electrode terminal and a negative electrode terminal that are formed of mutually different kinds of metal and a manufacturing method of the same.

2. Description of the Related Art

In recent years, it is advancing to put a nonaqueous electrolyte secondary battery typified by a lithium ion secondary battery into practical use. The nonaqueous electrolyte secondary battery has a high energy output per unit area (or per unit mass) in comparison with the other batteries such as a lead storage battery, thus it is expected to be applicable to a mobile communication device and a book-size personal computer, an electric car and a hybrid car, and further an electrical power storage system using renewable energy such as a solar battery.

The nonaqueous electrolyte secondary battery mentioned above includes an electrode group configured such that a separator is arranged between a positive electrode and a negative electrode so as to form a multilayer structure, an exterior body configured to accommodate the electrode group, and an electrolytic solution enclosed in the exterior body.

As a base material of the positive electrode, aluminum is used, and as a base material of the negative electrode, copper is used. To the positive electrode, a positive electrode terminal comprised of aluminum or an aluminum alloy is electrically connected, and to the negative electrode, a negative electrode terminal comprised of copper or a copper alloy is electrically connected.

In a small sized device that has a small output, the nonaqueous electrolyte secondary battery is used as single body, but in a large sized device that needs a large output, naturally, the output of the single body of the nonaqueous electrolyte secondary battery is not enough, thus a configuration that a plurality of the nonaqueous electrolyte secondary batteries are connected in series-parallel is adopted so as to obtain a desired output.

In this case, it is necessary that the positive electrode terminal and the negative electrode terminal are electrically connected to each other, but as mentioned above, the positive electrode terminal and the negative electrode terminal are mutually formed of different kinds of metal, thus it is required to join mutually different kinds of metals. In case of joining mutually different kinds of metals, it is concerned that corrosion and increase in resistance are caused in the joining part by a local battery effect due to difference in an ionization tendency of the metals.

Also, with regard to joining itself, there is a problem that it is difficult to obtain stable joining strength by using a popular technique such as a resistance welding as a technique for joining metals with each other due to difference in melting point that the respective metals have. If stable joining strength is not obtained, it is not preferable in terms of vibration resistance.

For example, JP-A-2011-210482 discloses an electrode terminal connection body configured such that a positive electrode connection part configured to be connectable to a positive electrode and a negative electrode connection part configured to connectable to a negative electrode are included, and the negative electrode connection part is arranged so as to surround the periphery of the positive electrode connection part or the positive electrode connection part is arranged so as to surround the periphery of the negative electrode connection part, and simultaneously the positive electrode connection part and the negative electrode connection part are integrally bonded by metallic bond.

In addition, JP-A-2012-89254 discloses an electrode terminal connection body configured such that an electrode part configured to be connected to one electrode terminal and be formed of the same kind of metal as a metal of the one electrode terminal, and a bus bar part configured to be connected to the electrode part and be formed of the same kind of metal as a metal of another electrode terminal are included, and the electrode part and the bus bar part are integrated by diffusion junction.

According to these electrode terminal connection bodies, the joining of the electrode terminal connection body and the electrode terminal can be configured to be a joining of the mutually same kind of metal so that an occurrence of corrosion and increase in resistance due to a local battery effect can be prevented in principle, and a simple technique such as a resistance welding as a technique for a joining of metals can be adopted.

### SUMMARY OF THE INVENTION

The electrode terminal connection bodies disclosed in JP-A-2011-210482 and JP-A-2012-89254 are configured by joining mutually different kinds of metals originally, thus there is a possibility that also in the joining part thereof, corrosion and increase in resistance due to a local battery effect are caused.

The electrode terminal connection bodies disclosed in JP-A-2011-210482 and JP-A-2012-89254 are configured such that the main base material occupying most of the whole volume is formed of the same kind of metal as a metal of the electrode terminal, thus there is hardly any room to select a material of the main base material in relation with the metal of which the electrode terminal is formed.

The main base material formed of the same kind of metal as a metal of the electrode terminal does not always have sufficient strength as an electrode terminal connection body, and does not always have low resistance, thus it is desired to provide an electrode terminal connection body configured such that a main base material can be freely selected.

It is an object of the invention to provide an electrode terminal connection body configured such that a main base material occupying most of the whole volume is free from limitation due to the metal of which the electrode terminal is formed and materials having various characteristics can be freely used as the main base material, and being capable of preventing an occurrence of corrosion and increase in resistance in the joining part thereof, as well as a manufacturing method of the electrode terminal connection body.

(1) According to one embodiment of the invention, an electrode terminal connection body, configured to electrically connect a positive electrode terminal and a negative electrode terminal that are formed of mutually different kinds of metals comprises:

a positive electrode terminal connection part formed of the same kind of metal as a metal of the positive electrode terminal; and

a negative electrode terminal connection part formed of the same kind of metal as a metal of the negative electrode terminal,

wherein the positive electrode terminal connection part and the negative electrode terminal connection part are connected via an interposing part formed of a metal that has an ionization tendency, between the metal of the positive electrode terminal and the metal of the negative electrode terminal.

(2) According to another embodiment of the invention, a manufacturing method for an electrode terminal connection body configured to electrically connect a positive electrode terminal and a negative electrode terminal that are formed of mutually different kinds of metals comprises:

applying a press processing to a thin plate formed of the same kind of metal as a metal of the positive electrode terminal so as to form a first mounting hole;

applying a press processing to a first thick plate formed of a metal that has an ionization tendency between the metal of the positive electrode terminal and the metal of the negative electrode terminal so as to form a first metal member that has a diameter smaller than the first mounting hole;

inserting the first metal member into the inside of the first mounting hole and simultaneously crushing the first metal member in the inside of the first mounting hole so as to join the thin plate and the first metal member while expanding the first mounting hole;

applying a press processing to the center part of the first metal member to allow the first metal member to remain in the inner peripheral part of the first mounting hole so as to form a second mounting hole;

applying a press processing to a second thick plate formed of the same kind of metal as a metal of the negative electrode terminal so as to form a second metal member that has a diameter smaller than the second mounting hole; and

inserting the second metal member into the inside of the second mounting hole and simultaneously crushing the second metal member in the inside of the second mounting hole so as to join the first metal member and the second metal member while expanding the second mounting hole.

In the above embodiment (2) of the invention, the following modifications and changes can be made.

(i) The manufacturing method further comprises:

applying a press processing to the thin plate so as to form a positive electrode terminal fixing hole; and

applying a press processing to the center part of the second metal member to allow the second metal member to remain in the inner peripheral part of the second mounting hole so as to form a negative electrode terminal fixing hole.

(3) According to another embodiment of the invention, a manufacturing method for an electrode terminal connection body configured to electrically connect a positive electrode terminal and a negative electrode terminal that are formed of mutually different kinds of metal comprises:

applying a negative electrode terminal connection part to a thin plate formed of the same kind of metal as a metal of the negative electrode terminal so as to form a first mounting hole;

applying a press processing to a first thick plate formed of a metal that has an ionization tendency between the metal of the positive electrode terminal and the metal of the negative electrode terminal so as to form a first metal member that has a diameter smaller than the first mounting hole;

inserting the first metal member into the inside of the first mounting hole and simultaneously crushing the first metal member in the inside of the first mounting hole so as to join the thin plate and the first metal member while expanding the first mounting hole;

applying a press processing to the center part of the first metal member to allow the first metal member to remain in the inner peripheral part of the first mounting hole so as to form a second mounting hole;

applying a press processing to a second thick plate formed of the same kind of metal as a metal of the positive electrode terminal so as to form a second metal member that has a diameter smaller than the second mounting hole; and

inserting the second metal member into the inside of the second mounting hole and simultaneously crushing the second metal member in the inside of the second mounting hole so as to join the first metal member and the second metal member while expanding the second mounting hole.

In the above embodiment (3) of the invention, the following modifications and changes can be made.

(ii) The manufacturing method further comprises:

applying a press processing to the thin plate so as to form a negative electrode terminal fixing hole; and

applying a press processing to the center part of the second metal member to allow the second metal member to remain in the inner peripheral part of the second mounting hole so as to form a positive electrode terminal fixing hole.

(4) According to another embodiment of the invention, a manufacturing method for an electrode terminal connection body configured to electrically connect a positive electrode terminal and a negative electrode terminal that are formed of mutually different kinds of metal comprises:

applying a press processing to a first plate member formed of the same kind of metal as a metal of the positive electrode terminal so as to form a first mounting hole;

applying a press processing to a second plate member formed of a metal that has an ionization tendency between the metal of the positive electrode terminal and the metal of the negative electrode terminal so as to form a first metal member that has a diameter larger than the first mounting hole;

press-fitting the first metal member into the inside of the first mounting hole so as to join the first plate member and the first metal member;

applying a press processing to the center part of the first metal member to allow the first metal member to remain in the inner peripheral part of the first mounting hole so as to form a second mounting hole;

applying a press processing to a third plate member formed of the same kind of metal as a metal of the negative electrode terminal so as to form a second metal member that has a diameter larger than the second mounting hole; and

press-fitting the second metal member into the inside of the second mounting hole so as to join the first metal member and the second metal member.

In the above embodiment (4) of the invention, the following modifications and changes can be made.

(iii) The manufacturing method further comprises:

applying a press processing to the first plate member so as to form a positive electrode terminal fixing hole; and

applying a press processing to the center part of the second metal member to allow the second metal member to remain in the inner peripheral part of the second mounting hole so as to form a negative electrode terminal fixing hole.

(5) According to another embodiment of the invention, a manufacturing method for an electrode terminal connection body configured to electrically connect a positive electrode terminal and a negative electrode terminal that are formed of mutually different kinds of metal comprises:

applying a press processing to a first plate member formed of the same kind of metal as a metal of the negative electrode terminal so as to form a first mounting hole;

applying a press processing to a second plate member formed of a metal that has an ionization tendency between the metal of the positive electrode terminal and the metal of the negative electrode terminal so as to form a first metal member that has a diameter larger than the first mounting hole;

press-fitting the first metal member into the inside of the first mounting hole so as to join the first plate member and the first metal member;

applying a press processing to the center part of the first metal member to allow the first metal member to remain in the inner peripheral part of the first mounting hole so as to form a second mounting hole;

applying a press processing to a third plate member formed of the same kind of metal as a metal of the positive electrode terminal so as to form a second metal member that has a diameter larger than the second mounting hole; and

press-fitting the second metal member into the inside of the second mounting hole so as to join the first metal member and the second metal member.

In the above embodiment (5) of the invention, the following modifications and changes can be made.

(iv) The manufacturing method further comprises:

applying a press processing to the first plate member so as to form a negative electrode terminal fixing hole; and

applying a press processing to the center part of the second metal member to allow the second metal member to remain in the inner peripheral part of the second mounting hole so as to form a positive electrode terminal fixing hole.

In the above embodiment (2), (3), (4) or (5) of the invention, the following modifications and changes can be made.

(v) The manufacturing method further comprises:

heating under an inert atmosphere after joining the first metal member and the second metal member.

(6) According to another embodiment of the invention, an electrode terminal connection body configured to electrically connect a positive electrode terminal and a negative electrode terminal that are formed of mutually different kinds of metals comprises:

a metal plate;

a positive electrode terminal connection part disposed in a part of the metal plate and formed of the same kind of metal as a metal of the positive electrode terminal; and

a negative electrode terminal connection part disposed in a part of the metal plate and formed of the same kind of metal as a metal of the negative electrode terminal.

In the above embodiment (6) of the invention, the following modifications and changes can be made.

(vi) The metal plate comprises an aluminum based material or a copper based material.

(7) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a positive electrode terminal side mounting hole and a negative electrode terminal side mounting hole;

applying a press processing to a positive electrode terminal side thick plate formed of the same kind of metal as a metal of the positive electrode terminal so as to form a positive electrode terminal side metal member that has a diameter smaller than the positive electrode terminal side mounting hole;

applying a press processing to a negative electrode terminal side thick plate formed of the same kind of metal as a metal of the negative electrode terminal so as to form a negative electrode terminal side metal member that has a diameter smaller than the negative electrode terminal side mounting hole; and

inserting the positive electrode terminal side metal member into the inside of the positive electrode terminal side mounting hole and simultaneously crushing the positive electrode terminal side metal member in the inside of the positive electrode terminal side mounting hole so as to join the metal plate and the positive electrode terminal side metal member while expanding the positive electrode terminal side mounting hole, and inserting the negative electrode terminal side metal member into the inside of the negative electrode terminal side mounting hole and simultaneously crushing the negative electrode terminal side metal member in the inside of the negative electrode terminal side mounting hole so as to join the metal plate and the negative electrode terminal side metal member while expanding the negative electrode terminal side mounting hole.

(8) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a positive electrode terminal side mounting hole and a negative electrode terminal side mounting hole;

applying a press processing to a positive electrode terminal side plate member formed of the same kind of metal as a metal of the positive electrode terminal so as to form a positive electrode terminal side metal member that has a diameter larger than the positive electrode terminal side mounting hole;

applying a press processing to a negative electrode terminal side plate member formed of the same kind of metal as a metal of the negative electrode terminal so as to form a negative electrode terminal side metal member that has a diameter larger than the negative electrode terminal side mounting hole; and

press-fitting the positive electrode terminal side metal member into the inside of the positive electrode terminal side mounting hole so as to join the metal plate and the positive electrode terminal side metal member, and press-fitting the negative electrode terminal side metal member into the inside of the negative electrode terminal side mounting hole so as to join the metal plate and the negative electrode terminal side metal member.

In the above embodiment (7) or (8) of the invention, the following modifications and changes can be made.

(vii) The metal plate comprises an aluminum based material or a copper based material.

(viii) The manufacturing method further comprises:

applying a press processing to the center part of the positive electrode terminal side metal member to allow the positive electrode terminal side metal member to remain in the inner peripheral part of the positive electrode terminal side mounting hole so as to form a positive electrode terminal fixing hole; and

applying a press processing to the center part of the negative electrode terminal side metal member to allow the negative electrode terminal side metal member to remain in the inner peripheral part of the negative electrode terminal side mounting hole so as to form a negative electrode terminal fixing hole.

(ix) The manufacturing method further comprises:

heating under an inert atmosphere after joining the metal plate and the positive electrode terminal side metal member, and joining the metal plate and the negative electrode terminal side metal member.

(9) According to another embodiment of the invention, an electrode terminal connection body configured to electrically connect a positive electrode terminal and a negative electrode terminal that are formed of mutually different kinds of metals comprises:

a metal plate;

a positive electrode terminal connection part disposed in a part of the metal plate and formed of the same kind of metal as a metal of the positive electrode terminal; and

a negative electrode terminal connection part disposed in a part of the metal plate and formed of the same kind of metal as a metal of the negative electrode terminal,

wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate.

In the above embodiment (9) of the invention, the following modifications and changes can be made.

(x) The metal plate comprises an aluminum based material or a copper based material.

(10) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a first positive electrode terminal side mounting hole and a first negative electrode terminal side mounting hole;

applying a press processing to a positive electrode terminal side interposing thick plate formed of a metal that has an ionization tendency between the metal of the positive electrode terminal and the metal of the metal plate so as to form a positive electrode terminal side interposing metal member that has a diameter smaller than the first positive electrode terminal side mounting hole;

applying a press processing to a negative electrode terminal side interposing thick plate formed of a metal that has an ionization tendency between the metal of the negative electrode terminal and the metal of the metal plate so as to form a negative electrode terminal side interposing metal member that has a diameter smaller than the first negative electrode terminal side mounting hole;

inserting the positive electrode terminal side interposing metal member into the inside of the first positive electrode terminal side mounting hole and simultaneously crushing the positive electrode terminal side imposing metal member in the inside of the first positive electrode terminal side mounting hole so as to join the metal plate and the positive electrode terminal side interposing metal member while expanding the first positive electrode terminal side mounting hole, and inserting the negative electrode terminal side interposing metal member into the inside of the first negative electrode terminal side mounting hole and simultaneously crushing the negative electrode terminal side imposing metal member in the inside of the first negative electrode terminal side mounting hole so as to join the metal plate and the negative electrode terminal side interposing metal member while expanding the first negative electrode terminal side mounting hole;

applying a press processing to the center part of the positive electrode terminal side interposing metal member to allow the positive electrode terminal side interposing metal member to remain in the inner peripheral part of the first positive electrode terminal side mounting hole so as to form a second positive electrode terminal mounting hole, and applying a press processing to the center part of the negative electrode terminal side interposing metal member to allow the negative electrode terminal side interposing metal member to remain in the inner peripheral part of the first negative electrode terminal side mounting hole so as to form a second negative electrode terminal mounting hole;

applying a press processing to a positive electrode terminal side thick plate formed of the same kind of metal as a metal of the positive electrode terminal so as to form a positive electrode terminal side metal member that has a diameter smaller than the second positive electrode terminal side mounting hole;

applying a press processing to a negative electrode terminal side thick plate formed of the same kind of metal as a metal of the negative electrode terminal so as to form a negative electrode terminal side metal member that has a diameter smaller than the second negative electrode terminal side mounting hole; and

inserting the positive electrode terminal side metal member into the inside of the second positive electrode terminal side mounting hole and simultaneously crushing the positive electrode terminal side metal member in the inside of the second positive electrode terminal side mounting hole so as to join the positive electrode terminal side interposing metal member and the positive electrode terminal side metal member while expanding the second positive electrode terminal side mounting hole, and inserting the negative electrode terminal side metal member into the second inside of the negative electrode terminal side mounting hole and simultaneously crushing the negative electrode terminal side metal member in the inside of the second negative electrode terminal side mounting hole so as to join the negative electrode terminal side interposing metal member and the negative electrode terminal side metal member while expanding the second negative electrode terminal side mounting hole.

(11) According to another embodiment of the invention, a manufacturing method for an electrode terminal connection body configured to electrically connect a positive electrode terminal and a negative electrode terminal that are formed of mutually different kinds of metals comprises:

applying a press processing to a metal plate so as to form a first positive electrode terminal side mounting hole and a first negative electrode terminal side mounting hole;

applying a press processing to a positive electrode terminal side interposing plate member formed of a metal that has an ionization tendency between the metal of the positive electrode terminal and the metal of the metal plate so as to form a positive electrode terminal side interposing metal member that has a diameter larger than the first positive electrode terminal side mounting hole;

applying a press processing to a negative electrode terminal side interposing plate member formed of a metal that has an ionization tendency between the metal of the negative electrode terminal and the metal of the metal plate so as to for in a negative electrode terminal side interposing metal member that has a diameter larger than the first negative electrode terminal side mounting hole;

press-fitting the positive electrode terminal side interposing metal member into the inside of the first positive electrode terminal side mounting hole so as to join the metal plate and the positive electrode terminal side interposing metal member, and press-fitting the negative electrode terminal side interposing metal member into the inside of the first negative electrode terminal side mounting hole so as to join the metal plate and the negative electrode terminal side interposing metal member;

applying a press processing to the center part of the positive electrode terminal side interposing metal member to allow the positive electrode terminal side interposing metal member to remain in the inner peripheral part of the first positive electrode terminal side mounting hole so as to form a second positive electrode terminal mounting hole, and applying a press processing to the center part of the negative electrode terminal side interposing metal member to allow the negative electrode terminal side interposing metal member to remain in the inner peripheral part of the first negative electrode terminal side mounting hole so as to form a second negative electrode terminal mounting hole;

applying a press processing to a positive electrode terminal side plate member formed of the same kind of metal as a metal of the positive electrode terminal so as to form a positive electrode terminal side metal member that has a diameter larger than the second positive electrode terminal side mounting hole;

applying a press processing to a negative electrode terminal side plate member formed of the same kind of metal as a metal of the negative electrode terminal so as to form a negative electrode terminal side metal member that has a diameter larger than the second negative electrode terminal side mounting hole; and

press-fitting the positive electrode terminal side metal member into the inside of the second positive electrode terminal side mounting hole so as to join the positive electrode terminal side interposing metal member and the positive electrode terminal side metal member, and press-fitting the negative electrode terminal side metal member into the inside of the second negative electrode terminal side mounting hole so as to join the negative electrode terminal side interposing metal member and the negative electrode terminal side metal member.

In the above embodiment (10) or (11) of the invention, the following modifications and changes can be made.

(xi) The metal plate comprises an aluminum based material or a copper based material.

(xii) The manufacturing method further comprises:

applying a press processing to the center part of the positive electrode terminal side metal member to allow the positive electrode terminal side metal member to remain in the inner peripheral part of the second positive electrode terminal side mounting hole so as to form a positive electrode terminal fixing hole; and

applying a press processing to the center part of the negative electrode terminal side metal member to allow the negative electrode terminal side metal member to remain in the inner peripheral part of the second negative electrode terminal side mounting hole so as to form a negative electrode terminal fixing hole.

(xiii) The manufacturing method further comprises:

heating under an inert atmosphere after joining the positive electrode terminal side interposing metal member and the positive electrode terminal side metal member, and joining the negative electrode terminal side interposing metal member and the negative electrode terminal side metal member.

### Effects of the Invention

According to one embodiment of the invention, an electrode terminal connection body can be provided that is configured such that a main base material occupying most of the whole volume is free from limitation due to the metal of which the electrode terminal is formed and materials having various characteristics can be freely used as the main base material, and is capable of preventing an occurrence of corrosion and increase in resistance in the joining part thereof, as well as a manufacturing method of the electrode terminal connection body.

### BRIEF DESCRIPTION OF THE DRAWINGS

The preferred embodiments according to the invention will be explained below referring to the drawings, wherein:

FIG. 1A is a top view schematically showing an electrode terminal connection body according to a first embodiment of the invention;

FIG. 1B is a cross-sectional view taken along the line A-A in FIG. 1A;

FIG. 2 is a perspective view schematically showing a battery system configured such that a plurality of nonaqueous electrolyte secondary batteries are connected in series;

FIGS. 3A to 3H are cross-sectional views schematically showing a manufacturing method (an expansion type) of the electrode terminal connection body according to the first embodiment of the invention;3

FIGS. 4A to 4H are cross-sectional views schematically showing a manufacturing method (a press-fitting type) of the electrode terminal connection body according to the first embodiment of the invention;

FIG. 5A is a top view schematically showing an electrode terminal connection body according to a second embodiment of the invention;

FIG. 5B is a cross-sectional view taken along the line A-A in FIG. 5A;

FIG. 6 is a perspective view schematically showing a battery system configured such that a plurality of nonaqueous electrolyte secondary batteries are connected in series;

FIGS. 7A to 7E are cross-sectional views schematically showing a manufacturing method (an expansion type) of the electrode terminal connection body according to the second embodiment of the invention;

FIGS. 8A to 8E are cross-sectional views schematically showing a manufacturing method (a press-fitting type) of the electrode terminal connection body according to the second embodiment of the invention;

FIG. 9A is a top view schematically showing an electrode terminal connection body according to a third embodiment of the invention;

FIG. 9B is a cross-sectional view taken along the line A-A in FIG. 9A;

FIG. 10 is a perspective view schematically showing a battery system configured such that a plurality of nonaqueous electrolyte secondary batteries are connected in series;

FIGS. 11A to 11H are cross-sectional views schematically showing a manufacturing method (an expansion type) of the electrode terminal connection body according to the third embodiment of the invention; and

FIGS. 12A to 12H are cross-sectional views schematically showing a manufacturing method (a press-fitting type) of the electrode terminal connection body according to the third embodiment of the invention.

### DETAILED DESCRIPTION OF THE PREFERRED EMBODIMENTS

Hereinafter, the preferred first embodiment according to the invention will be explained below referring to the drawings.

First, an electrode terminal connection body will be explained.

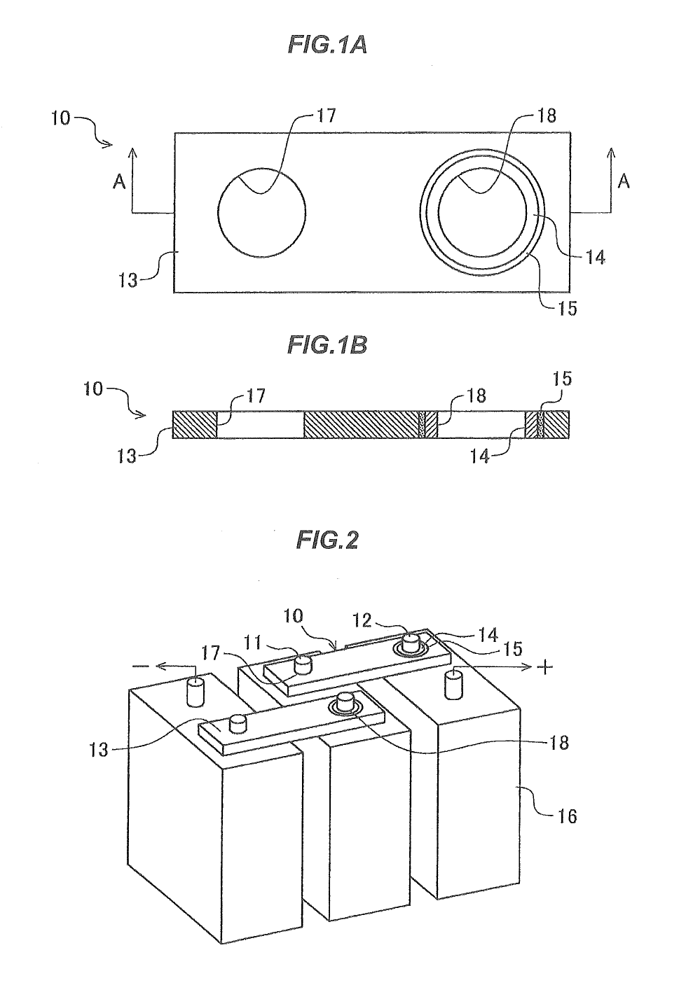

As shown in FIGS. 1A, 1B and FIG. 2, the electrode terminal connection body 10 according to the first embodiment is configured to electrically connect a positive electrode terminal 11 and a negative electrode terminal 12 that are formed of mutually different kinds of metals, and includes a positive electrode terminal connection part 13 formed of the same kind of metal as a metal of the positive electrode terminal 11 and a negative electrode terminal connection part 14 formed of the same kind of metal as a metal of the negative electrode terminal 12, wherein the positive electrode terminal connection part 13 and the negative electrode terminal connection part 14 are connected via an interposing part 15 formed of a metal that has an ionization tendency between the metal of the positive electrode terminal 11 and the metal of the negative electrode terminal 12.

The positive electrode terminal 11 and the negative electrode terminal 12 are respectively formed so as to extend from the nonaqueous electrolyte secondary battery 16. The positive electrode terminal 11 is comprised of aluminum or an aluminum alloy, and the negative electrode terminal 12 is comprised of copper or a copper alloy.

A plurality of the nonaqueous electrolyte secondary batteries 16 are connected in series-parallel via the electrode terminal connection body 10, for example, constitutes a battery system that is mounted in an electric car and a hybrid car as a motive power thereof.

The positive electrode terminal connection part 13 is a part that is configured to be electrically connected to the positive electrode terminal 11 and the negative electrode terminal connection part 14 is a part that is configured to be electrically connected to the negative electrode terminal 12.

Here, a configuration that the same kind of metal as a metal of the positive electrode terminal 11 is used as a main base material is explained, but not limited to this, a configuration that the same kind of metal as a metal of the negative electrode terminal 12 is used as a main base material and the positive electrode terminal connection part 13 is formed in a part of the negative electrode terminal connection part 14 can be also adopted.

In the positive electrode terminal connection part 13, a positive electrode terminal fixing hole 17 is formed, the positive electrode terminal fixing hole 17 being configured such that the positive electrode terminal 11 is inserted therein so as to be fixed by resistance welding or the like, and in the negative electrode terminal connection part 14, a negative electrode terminal fixing hole 18 is formed, the negative electrode terminal fixing hole 18 being configured such that the negative electrode terminal 12 is inserted therein so as to be fixed by resistance welding or the like.

The interposing part 15 is configured to prevent an occurrence of corrosion and increase in resistance in the joining part of the positive electrode terminal connection part 13 and the negative electrode terminal connection part 14, and for example, is comprised of nickel, chromium, zinc or the like.

Here, a metal of the interposing part 15 is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the interposing part 15. The reason is that an ionization permutation exhibiting the ionization tendency corresponds to electrochemical series exhibiting the standard electrode potential that is represented by using hydrogen as a standard electrode.

In accordance with the electrode terminal connection body 10 according to the first embodiment, the positive electrode terminal connection part 13 and the negative electrode terminal connection part 14 are connected via the interposing part 15 formed of a metal that has an ionization tendency between the metal of the positive electrode terminal 11 and the metal of the negative electrode terminal 12, thus the change of not only the ionization tendency in the connection interface between the positive electrode terminal connection part 13 and the negative electrode terminal connection part 14, but also the electric potential difference of the standard electrode potential in the connection interface can be reduced, and an occurrence of corrosion and increase in resistance in the joining part of the electrode terminal connection body 10 due to a local battery effect can be prevented.

Next, a manufacturing method of the electrode terminal connection body will be explained. In the manufacturing method of the electrode terminal connection body, an expansion type manufacturing method and a press-fitting type manufacturing method are mainly included, thus these manufacturing methods will be explained in order.

First, the expansion type manufacturing method will be explained.

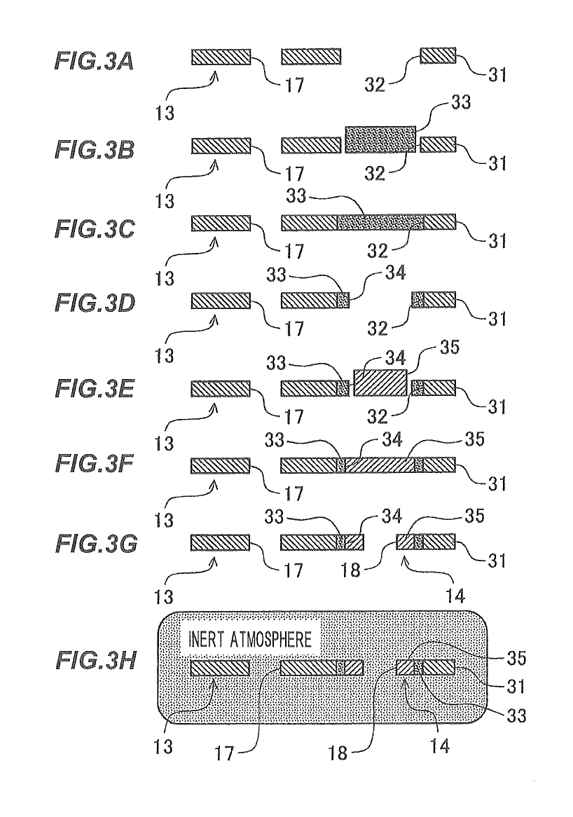

As shown in FIGS. 3A to 3H, the expansion type manufacturing method includes applying a press processing to a thin plate 31 formed of the same kind of metal as a metal of the positive electrode terminal 11 so as to form a first mounting hole 32, applying a press processing to a first thick plate (not shown) formed of a metal that has an ionization tendency between the metal of the positive electrode terminal 11 and the metal of the negative electrode terminal 12 so as to form a first metal member 33 that has a diameter smaller than the first mounting hole 32, inserting the first metal member 33 into the inside of the first mounting hole 32 and simultaneously crushing the first metal member 33 in the inside of the first mounting hole 32 so as to join the thin plate 31 and the first metal member 33 while expanding the first mounting hole 32, applying a press processing to the center part of the first metal member 33 to allow the first metal member 33 to remain in the inner peripheral part of the first mounting hole 32 so as to form a second mounting hole 34, applying a press processing to a second thick plate (not shown) formed the same kind of metal as a metal of the negative electrode terminal 12 so as to form a second metal member 35 that has a diameter smaller than the second mounting hole 34, and inserting the second metal member 35 into the inside of the second mounting hole 34 and simultaneously crushing the second metal member 35 in the inside of the second mounting hole 34 so as to join the first metal member 33 and the second metal member 35 while expanding the second mounting hole 34.

Further, in FIGS. 3A to 3H, for convenience of explanation, a part of lines in the cross-sectional views is omitted.

Hereinafter, the respective steps will be concretely explained.

The step of applying a press processing to the thin plate 31 formed of the same kind of metal as a metal of the positive electrode terminal 11 so as to form the first mounting hole 32 is particularly carried out to apply a press processing (especially, a punching work) to the thin plate 31 formed of aluminum or an aluminum alloy so as to form the first mounting hole 32, and further to form the positive electrode terminal fixing hole 17 so as to form the positive electrode terminal connection part 13 (refer to FIG. 3A). Just after this step, an oxidizing film is not formed in the inner peripheral surface of the first mounting hole 32.

Thereby, when the positive electrode terminal 11 is inserted into the positive electrode terminal fixing hole 17 so as to be fixed by resistance welding or the like, the positive electrode terminal 11 and the thin plate 31 that are mutually formed of the same kind of metal are brought into contact with each other so that the joining of the mutually same kind of metal can be realized.

The step of applying a press processing to the first thick plate formed of a metal that has an ionization tendency between the metal of the positive electrode terminal 11 and the metal of the negative electrode terminal 12 so as to form a first metal member 33 that has a diameter smaller than the first mounting hole 32 is particularly carried out to apply a press processing (especially, a punching work) to the first thick plate formed of nickel, chromium, zinc or the like so as to form the first metal member 33 that becomes the interposing part 15. The first thick plate has a thickness larger than the thin plate 31, thus the first metal member 33 has a thickness larger than the thin plate 31 similarly.

Here, a metal of the first thick plate is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the first thick plate. The reason is that an ionization permutation exhibiting the ionization tendency corresponds to electrochemical series exhibiting the standard electrode potential that is represented by using hydrogen as a standard electrode.

The step of inserting the first metal member 33 into the inside of the first mounting hole 32 and simultaneously crushing the first metal member 33 in the inside of the first mounting hole 32 so as to join the thin plate 31 and the first metal member 33 while expanding the first mounting hole 32 is particularly carried out to crush the first metal member 33 in the inside of the first mounting hole 32 by a blanking punch of a press device (refer to FIGS. 3B and 3C).

At this time, the first metal member 33 is crushed, and is rolled so as to have a diameter larger than the inner diameter of the first mounting hole 32, in association with this, the first mounting hole 32 is expanded. As a result, even if an oxide film is slightly formed in the inner peripheral surface of the first mounting hole 32, the oxide film is broken just before the joining, and generation of a newly formed surface is accelerated so that diffusion joining can be carried out between aluminum or the like of the thin plate 31 and nickel or the like of the first metal member 33.

Consequently, aluminum or the like of the thin plate 31 and nickel or the like of the first metal member 33 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, aluminum or the like of the thin plate 31 and nickel or the like of the first metal member 33 have the respective ionization tendencies being close together, thus even if these mutually different kinds of metals are joined, in principle, corrosion and increase in resistance by a local battery effect is hard to occur.

The step of applying a press processing to the center part of the first metal member 33 so as to allow the first metal member 33 to remain in the inner peripheral part of the first mounting hole 32 so as to form the second mounting hole 34 is particularly carried out to apply a press processing (especially, a punching work) to the first metal member 33 so as to allow the first metal member 33 to remain over the entire inner periphery of the first mounting hole 32 in a sufficient thickness in the diameter direction (refer to FIG. 3D).

Thereby, in a post process, when the second metal member 35 is inserted into the second mounting hole 34 so as to join the first metal member 33 and the second metal member 35, mutually different kinds of metals that have the respective ionization tendencies being close together, are joined, thus an occurrence of corrosion and increase in resistance by a local battery effect can be effectively prevented.

The step of applying a press processing to the second thick plate formed of the same kind of metal as a metal of the negative electrode terminal 12 so as to form the second metal member 35 that has a diameter smaller than the second mounting hole 34 is particularly carried out to apply a press processing (especially, a punching work) to the second thick plate formed of copper or a copper alloy so as to form the second metal member 35. The second thick plate has a thickness larger than the thin plate 31, thus the second metal member 35 has a thickness larger than the thin plate 31 similarly.

The step of inserting the second metal member 35 into the inside of the second mounting hole 34 and simultaneously crushing the second metal member 35 in the inside of the second mounting hole 34 so as to join the first metal member 33 and the second metal member 35 while expanding the second mounting hole 34 is particularly carried out to crush the second metal member 35 in the inside of the second mounting hole 34 by a blanking punch of a press device (refer to FIGS. 3E and 3F).

At this time, the second metal member 35 is crushed, and is rolled so as to have a diameter larger than the inner diameter of the second mounting hole 34, in association with this, the second mounting hole 34 is expanded. As a result, even if an oxide film is slightly formed in the inner peripheral surface of the second mounting hole 34, the oxide film is broken just before the joining, and generation of a newly formed surface is accelerated so that diffusion joining can be carried out between nickel or the like of the first metal member 33 and copper or the like of the second metal member 35.

Therefore, nickel or the like of the first metal member 33 and copper or the like of the second metal member 35 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, nickel or the like of the first metal member 33 and copper or the like of the second metal member 35 have the respective ionization tendencies being close together, thus even if these mutually different kinds of metals are joined, in principle, corrosion and increase in resistance by a local battery effect is hard to occur.

A press processing has a processing speed higher than the other processing method, thus the above-mentioned steps can be continuously carried out by a press device, thereby work and operation from the forming of the first mounting hole 32 to the joining of the thin plate 31 and the first metal member 33, and work and operation from the forming of the second mounting hole 34 to the first metal member 33 and the second metal member 35 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the second metal member 35 joined to the thin plate 31 via the first metal member 33 so as to form the negative electrode terminal fixing hole 18 and fabricate the negative electrode terminal connection part 14 (refer to FIG. 3G).

At this time, a press processing is applied to the center part of the second metal member 35 to allow the second metal member 35 to remain in the inner peripheral part of the second mounting hole 34 so as to form the negative electrode terminal fixing hole 18.

Thereby, when the negative electrode terminal 12 is inserted into the negative electrode terminal fixing hole 18 so as to be fixed by resistance welding or the like, the negative electrode terminal 12 and the second metal member 35 that are mutually formed of the same kind of metal are brought into contact with each other so that the joining of the mutually same kind of metal can be realized.

Further, when the negative electrode terminal fixing hole 18 is formed, in order to prevent the joining of mutually different kinds of metals it is preferable that the first metal member 33 is not exposed in the inner peripheral surface of the negative electrode terminal fixing hole 18 that comes into contact with the negative electrode terminal 12.

In addition, it is preferable that the expansion type manufacturing method further includes the step of heating under an inert atmosphere after joining the first metal member 33 and the second metal member 35 (refer to FIG. 3H).

Thereby, diffusion joining between aluminum or the like of the thin plate 31 and nickel or the like of the first metal member 33 and diffusion joining between nickel or the like of the first metal member 33 and copper or the like of the second metal member 35 are sufficiently progressed so that joining strength can be further heightened.

As the inert atmosphere, a helium gas atmosphere or an argon gas atmosphere can be used. The heating temperature is controlled to a temperature not more than the melting point of the thin plate 31, the first metal member 33 and the second metal member 35 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the thin plate 31 that is the same kind of metal as a metal of the positive electrode terminal 11, and the negative electrode terminal fixing hole 18 that comes into contact with the negative electrode terminal 12 is formed of the second metal member 35 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, the press-fitting type manufacturing method will be explained.

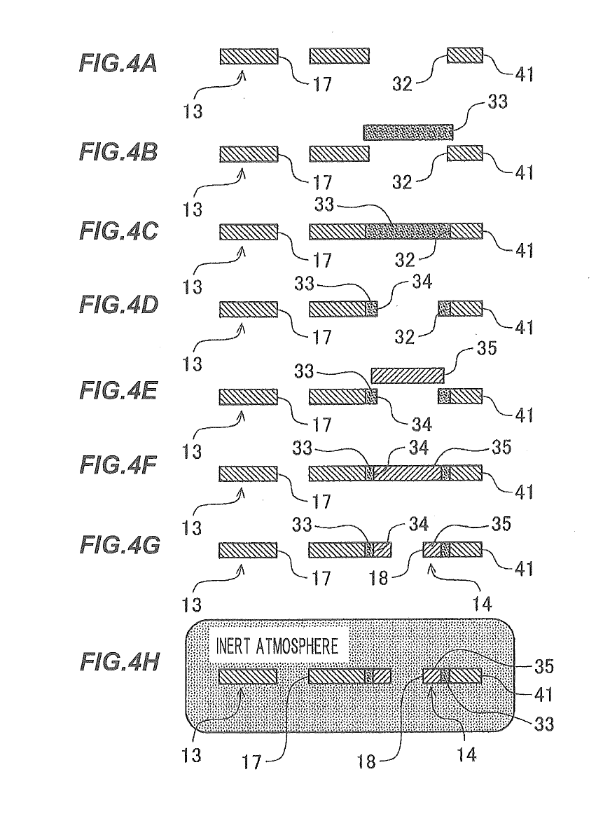

As shown in FIGS. 4A to 4H, the press-fitting type manufacturing method includes applying a press processing to a first plate 41 member formed of the same kind of metal as a metal of the first mounting hole 32, applying a press processing to a second plate member (not shown) formed of a metal that has an ionization tendency between the metal of the positive electrode terminal 11 and the metal of the negative electrode terminal 12 so as to form a first metal member 33 that has a diameter larger than the first mounting hole 32, press-fitting the first metal member 33 into the inside of the first mounting hole 32 so as to join the first plate member 41 and the first metal member 33, applying a press processing to the center part of the first metal member 33 to allow the first metal member 33 to remain in the inner peripheral part of the first mounting hole 32 so as to form a second mounting hole 34, applying a press processing to a third plate member (not shown) formed of the same kind of metal as a metal of the negative electrode terminal 12 so as to form a second metal member 35 that has a diameter larger than the second mounting hole 34, and press-fitting the second metal member 35 into the inside of the second mounting hole 34 so as to join the first metal member 33 and the second metal member 35.

Further, in FIGS. 4A to 4H, for convenience of explanation, a part of lines in the cross-sectional views is omitted.

Hereinafter, the respective steps will be concretely explained.

The step of applying a press processing to a first plate 41 member formed of the same kind of metal as a metal of the positive electrode terminal 11 so as to form a first mounting hole 32 is particularly carried out to apply a press processing (especially, a punching work) to the first plate 41 member formed of aluminum or an aluminum alloy so as to form the first mounting hole 32, and further to form the positive electrode terminal fixing hole 17 so as to fabricate the positive electrode terminal connection part 13 (refer to FIG. 4A). Just after this step, an oxidizing film is not formed in the inner peripheral surface of the first mounting hole 32.

The step of applying a press processing to the second plate member formed of a metal that has an ionization tendency between the metal of the positive electrode terminal 11 and the metal of the negative electrode terminal 12 so as to form the first metal member 33 that has a diameter larger than the first mounting hole 32 is particularly carried out to apply a press processing (especially, a punching work) to the second plate member formed of nickel, chromium, zinc or the like so as to form the first metal member 33 that becomes the interposing part 15. The second plate member has a thickness equal to the first plate member 41, thus the first metal member 33 has a thickness equal to the first plate member 41 similarly.

Here, a metal of the second plate member is selected based on an ionization tendency, but a configuration using a base other than the ionization tendency can be adopted, that a metal having a standard electrode potential located between the metal of the positive electrode terminal 11 and the metal of the negative electrode terminal 12 is selected as the metal of the second plate member. The reason is that an ionization permutation exhibiting the ionization tendency corresponds to electrochemical series exhibiting the standard electrode potential that is represented by using hydrogen as a standard electrode.

The step of press-fitting the first metal member 33 into the inside of the first mounting hole 32 so as to join the first plate member 41 and the first metal member 33 is particularly carried out to press-fit the first metal member 33 into the inside of the first mounting hole 32 by a blanking punch of a press device (refer to FIGS. 4B and 4C).

At this time, the first metal member 33 and the first mounting hole 32 are brought into contact with each other so that the first metal member 33 is press-fitted into the inside of the first mounting hole 32 while being mutually scraped in their surfaces and performing plastic deformation. As a result, even if an oxide film is slightly formed in the inner peripheral surface of the first mounting hole 32, the oxide film is broken just before the joining, and generation of a newly formed surface is accelerated so that diffusion joining can be carried out between aluminum or the like of the first plate member 41 and nickel or the like of the first metal member 33.

Consequently, aluminum or the like of the first plate member 41 and nickel or the like of the first metal member 33 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, aluminum or the like of the first plate member 41 and nickel or the like of the first metal member 33 have the respective ionization tendencies being close together, thus even if these mutually different kinds of metals are joined, in principle, corrosion and increase in resistance by a local battery effect is hard to occur.

The step of applying a press processing to the center part of the first metal member 33 to allow the first metal member 33 to remain in the inner peripheral part of the first mounting hole 32 so as to form the second mounting hole 34 is particularly carried out to apply a press processing (especially, a punching work) to the first metal member 33 so as to allow the first metal member 33 to remain over the entire inner periphery of the first mounting hole 32 in a sufficient thickness in the diameter direction (refer to FIG. 4D).

Thereby, in a post process, when the second metal member 35 is press-fitted into the second mounting hole 34 so as to join the first metal member 33 and the second metal member 35, mutually different kinds of metals that have the respective ionization tendencies being close together, are joined, thus an occurrence of corrosion and increase in resistance by a local battery effect can be effectively prevented.

The step of applying a press processing to the third plate member formed of the same kind of metal as a metal of the negative electrode terminal 12 so as to form the second metal member 35 that has a diameter larger than the second mounting hole 34 is particularly carried out to apply a press processing (especially, a punching work) to the third plate member formed of copper or a copper alloy so as to form a second metal member 35. The third plate member has a thickness equal to the first plate member 41, thus the second metal member 35 has a thickness equal to the first plate member 41 similarly.

The step of press-fitting the second metal member 35 into the inside of the second mounting hole 34 so as to join the first metal member 33 and the second metal member 35 is particularly carried out to press-fit the second metal member 35 into the inside of the second mounting hole 34 by a blanking punch of a press device (refer to FIGS. 4E and 4F).

At this time, the second metal member 35 and the second mounting hole 34 are brought into contact with each other so that the second metal member 35 is press-fitted into the inside of the second mounting hole 34 while being mutually scraped in their surfaces and performing plastic deformation. As a result, even if an oxide film is slightly formed in the inner peripheral surface of the second mounting hole 34, the oxide film is broken just before the joining, and generation of a newly formed surface is accelerated so that diffusion joining can be carried out between nickel or the like of the first metal member 33 and copper or the like of the second metal member 35.

Consequently, nickel or the like of the first metal member 33 and copper or the like of the second metal member 35 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, nickel or the like of the first metal member 33 and copper or the like of the second metal member 35 have the respective ionization tendencies being close together, thus even if these mutually different kinds of metals are joined, in principle, corrosion and increase in resistance by a joining local battery effect is hard to occur.

A press processing has a processing speed higher than the other processing method, thus the above-mentioned steps can be continuously carried out by a press device, thereby work and operation from the forming of the first mounting hole 32 to the joining of the first plate member 41 and the first metal member 33, and work and operation from the forming of the second mounting hole 34 to the first metal member 33 and the second metal member 35 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by press-fitting is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the second metal member 35 joined to the first plate member 41 via the first metal member 33 so as to form the negative electrode terminal fixing hole 18 and fabricate the negative electrode terminal connection part 14 (refer to FIG. 4G).

At this time, a press processing is applied to the center part of the second metal member 35 to allow the second metal member 35 to remain in the inner peripheral part of the second mounting hole 34 so as to form the negative electrode terminal fixing hole 18.

Thereby, when the negative electrode terminal 12 is inserted into the negative electrode terminal fixing hole 18 so as to be fixed by resistance welding or the like, the negative electrode terminal 12 and the second metal member 35 that are mutually formed of the same kind of metal are brought into contact with each other so that the joining of the mutually same kind of metal can be realized.

Further, when the negative electrode terminal fixing hole 18 is formed, in order to prevent the joining of mutually different kinds of metals, it is preferable that the first metal member 33 is not exposed in the inner peripheral surface of the negative electrode terminal fixing hole 18 that comes into contact with the negative electrode terminal 12.

In addition, it is preferable that the press-fitting type manufacturing method further includes the step of heating under an inert atmosphere after joining the first metal member 33 and the second metal member 35 (refer to FIG. 4H).

Thereby, diffusion joining between aluminum or the like of the first plate member 41 and nickel or the like of the first metal member 33 and diffusion joining between nickel or the like of the first metal member 33 and copper or the like of the second metal member 35 are sufficiently progressed so that joining strength can be further heightened.

As the inert atmosphere, a helium gas atmosphere or an argon gas atmosphere can be used. The heating temperature is controlled to a temperature not more than the melting point of the first plate member 41, the first metal member 33 and the second metal member 35 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the first plate member 41 that is the same kind of metal as a metal of the positive electrode terminal 11, and the negative electrode terminal fixing hole 18 that comes into contact with the negative electrode terminal 12 is formed of the second metal member 35 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, an operation and effect of the manufacturing method of the electrode terminal connection body will be explained.

The electrode terminal connection bodies described in JP-2011-210482 A1 and JP-2012-89254 A1 are manufactured by forming an intermediate product in which mutually different kinds of metals are joined, by a hydrostatic extrusion processing, and applying to the intermediate product so as to obtain an electrode terminal connection body having a plate-like shape.

In order to carry out a hydrostatic extrusion processing, a large-scaled facility is needed, and in order to apply a cutting processing to the intermediate product so as to obtain an electrode terminal connection body having a plate-like shape, a long time is needed and simultaneously waste of chip is increased, thus it is estimated that production cost is extremely increased.

In addition, JP-2011-210482 A1 discloses that an electrode terminal connection body is manufactured by forming a mounting hole in a plate material and press-fitting a metal member formed of a different kind of metal into the mounting hole, but there is a risk that before the metal member is press-fitted into the mounting hole, an oxide film is grown on the surface of aluminum or an aluminum alloy so that sufficient joining strength cannot be obtained between mutually different kinds of metals.

On the other hand, in accordance with the manufacturing method of the electrode terminal connection body according to the first embodiment, the steps from the forming of the first mounting hole 32 to the joining of the second metal member 35 are carried out by a press processing that is excellent in a processing speed and can be operated by a small-scaled facility in comparison with a hydrostatic extrusion processing, so that a large-scaled facility is not needed and the steps from the forming of the first mounting hole 32 to the joining of the second metal member 35 can be carried out in a short time.

In addition, in the manufacturing method of the electrode terminal connection body, the processing speed of the steps from the forming of the first mounting hole 32 to the joining of the second metal member 35 is higher than that of a case of using a hydrostatic extrusion processing and/or a cutting processing together so that the growth of oxide film can be prevented during the processing.

Furthermore, in the manufacturing method of the electrode terminal connection body, when the first mounting hole 32 and the first metal member 33 are joined, and when the second mounting hole 34 and the second metal member 35 are joined, even if an oxide film is slightly formed in the inner peripheral surface of the first mounting hole 32 or the second mounting hole 34, just before the joining, the oxide film can be broken and diffusion joining can be applied to mutually different kinds of metals so that sufficient joining strength can be obtained between mutually different kinds of metals.

Namely, in accordance with the manufacturing method of the electrode terminal connection body according to the embodiment, a large-scaled facility is not needed and the steps from the forming of the mounting hole to the joining of the metal member can be carried out in a short time, so that the electrode terminal connection body 10 can be obtained, the electrode terminal connection body 10 being capable of preventing the growth of oxide film to a minimum so as to be joined and realizing a sufficient joining strength between mutually different kinds of metals.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, the first embodiment is configured such that the thin plate 31 or the first plate member 41 is formed of aluminum or the like that is the same kind of metal as a metal of the positive electrode terminal 11 and the second metal member 35 is formed of copper or the like that is the same kind of metal as a metal of the negative electrode terminal 12, but not limited to this, the thin plate 31 or the first plate member 41 may be also formed of copper or the like that is the same kind of metal as a metal of the negative electrode terminal 12 and the second metal member 35 may be also formed of aluminum or the like that is the same kind of metal as a metal of the positive electrode terminal 11.

Also, in this case, when the first mounting hole 32 and the first metal member 33 are joined, and when the second mounting hole 34 and the second metal member 35 are joined, even if an oxide film is slightly formed in the inner peripheral surface of the first mounting hole 32 or the second mounting hole 34, just before the joining, the oxide film can be broken by the expansion or press-fitting, and generation of a newly formed surface is accelerated so that sufficient joining strength can be obtained between mutually different kinds of metals.

In addition, the first embodiment is configured such that in the expansion type manufacturing method, all of the joinings are carried out by the expansion, and in the press-fitting type manufacturing method, all of the joinings are carried out by the press-fitting, but not limited to this, a combination of the joining by the expansion and the joining by the press-fitting may be also adopted.

As mentioned above, according to the first embodiment of the invention, an electrode terminal connection body and a manufacturing method of the electrode terminal connection body can be provided, the electrode terminal connection body being capable of preventing an occurrence of corrosion and increase in resistance in the joining part thereof.

Hereinafter, the preferred second embodiment according to the invention will be explained below referring to the drawings.

First, an electrode terminal connection body will be explained.

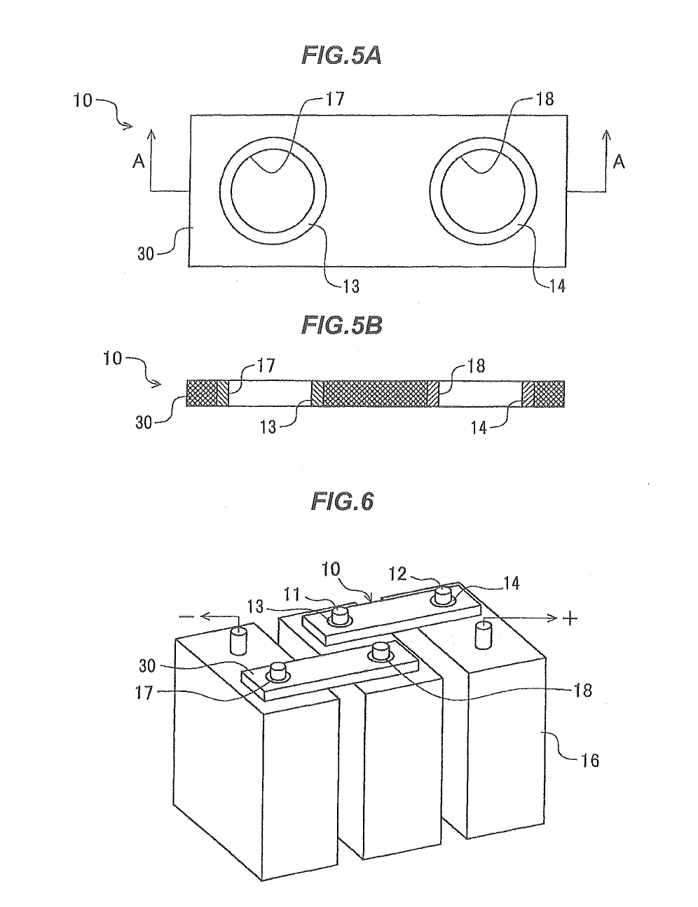

As shown in FIGS. 5A, 5B and FIG. 6, the electrode terminal connection body 10 according to the second embodiment is configured to electrically connect a positive electrode terminal 11 and a negative electrode terminal 12 that are formed of mutually different kinds of metals, and includes a metal plate 30, a positive electrode terminal connection part 13 disposed in a part of the metal plate 30 and formed of the same kind of metal as a metal of the positive electrode terminal 11 and a negative electrode terminal connection part 14 disposed in a part of the metal plate 30 and formed of the same kind of metal as a metal of the negative electrode terminal 12.

The positive electrode terminal 11 and the negative electrode terminal 12 are respectively formed so as to extend from the nonaqueous electrolyte secondary battery 16. The positive electrode terminal 11 is comprised of aluminum or an aluminum alloy, and the negative electrode terminal 12 is comprised of copper or a copper alloy.

A plurality of the nonaqueous electrolyte secondary batteries 16 are connected in series-parallel via the electrode terminal connection body 10, for example, constitutes a battery system that is mounted in an electric car and a hybrid car as a motive power thereof.

It is preferable that the metal plate 30 is comprised of an aluminum based material or a copper based material. This is because the aluminum based material is selected as a material of the metal plate 30, thereby a weight reduction of the electrode terminal connection body 10 can be realized, in addition, the copper based material is selected as a material of the metal plate 30, thereby a resistance reduction of the electrode terminal connection body 10 can be realized (conductivity thereof can be heightened).

A specific embodiment of the aluminum based material includes pure aluminum, and a specific embodiment of the copper based material includes tough pitch copper, oxygen free copper and the like.

Further, a configuration that a material of the metal plate 30 is formed of the same kind of material as a material of the positive electrode terminal connection part 13 or the negative electrode terminal connection part 14 shall not be excluded.

The positive electrode terminal connection part 13 is a part that is configured to be electrically connected to the positive electrode terminal 11 and the negative electrode terminal connection part 14 is a part that is configured to be electrically connected to the negative electrode terminal 12.

In the positive electrode terminal connection part 13, a positive electrode terminal fixing hole 17 is formed, the positive electrode terminal fixing hole 17 being configured such that the positive electrode terminal 11 is inserted therein so as to be fixed by resistance welding or the like, and in the negative electrode terminal connection part 14, a negative electrode terminal fixing hole 18 is formed, the negative electrode terminal fixing hole 18 being configured such that the negative electrode terminal 12 is inserted therein so as to be fixed by resistance welding or the like.

In accordance with the electrode terminal connection body 10 according to the second embodiment, the main base material that occupies most of the whole volume is formed of the metal plate 30, thus a material of the metal plate 30 is changed in accordance with purposes, thereby materials having various characteristics can be freely used as the main base material.

In addition, the electrode terminal connection body 10 is configured such that the positive electrode terminal connection part 13 and the negative electrode terminal connection part 14 that are formed of a material different from that of the metal plate 30 are disposed in only a part of the metal plate 30, thus material characteristics of the positive electrode terminal connection part 13 and the negative electrode terminal connection part 14 exert an extremely small influence on the whole characteristics of the electrode terminal connection body 10 so that characteristics of the electrode terminal connection body 10 can be freely designed by selecting a material of the metal plate 30.

Next, a manufacturing method of the electrode terminal connection body will be explained. In the manufacturing method of the electrode terminal connection body, an expansion type manufacturing method and a press-fitting type manufacturing method are mainly included, thus these manufacturing methods will be explained in order.

First, the expansion type manufacturing method will be explained.

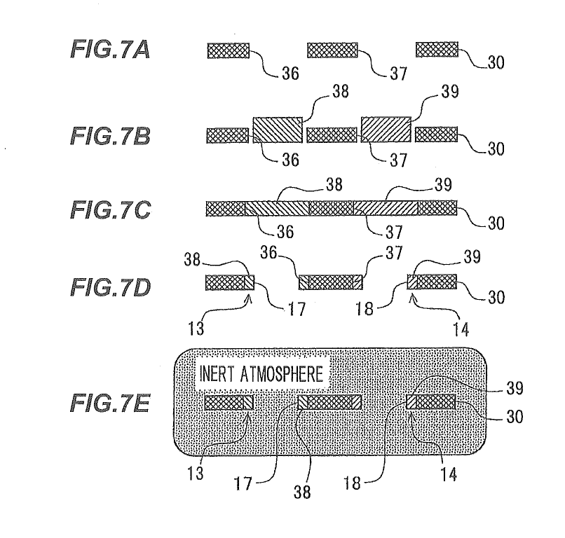

As shown in FIGS. 7A to 7E, the expansion type manufacturing method includes applying a press processing to a metal plate 30 so as to form a positive electrode terminal side mounting hole metal plate 36 and a negative electrode terminal side mounting hole 37, applying a press processing to a positive electrode terminal side thick plate (not shown) formed of the same kind of metal as a metal of the positive electrode terminal 11 so as to form a positive electrode terminal side metal member 38 that has a diameter smaller than the positive electrode terminal side mounting hole 36, applying a press processing to a negative electrode terminal side thick plate (not shown) formed of the same kind of metal as a metal of the negative electrode terminal 12 so as to form a negative electrode terminal side metal member 39 that has a diameter smaller than the negative electrode terminal side mounting hole 37, and inserting the positive electrode terminal side metal member 38 into the inside of the positive electrode terminal side mounting hole 36 and simultaneously crushing the positive electrode terminal side metal member 38 in the inside of the positive electrode terminal side mounting hole 36 so as to join the metal plate 30 and the positive electrode terminal side metal member 38 while expanding the positive electrode terminal side mounting hole 36, and inserting the negative electrode terminal side metal member 39 into the inside of the negative electrode terminal side mounting hole 37 and simultaneously crushing the negative electrode terminal side metal member 39 in the inside of the negative electrode terminal side mounting hole 37 so as to join the metal plate 30 and the negative electrode terminal side metal member 39 while expanding the negative electrode terminal side mounting hole 37.

Further, in FIGS. 7A to 7E, for convenience of explanation, a part of lines in the cross-sectional views is omitted.

Hereinafter, the respective steps will be concretely explained.

The step of applying a press processing to a metal plate 30 so as to form a positive electrode terminal side mounting hole 36 and a negative electrode terminal side mounting hole 37 is particularly carried out to apply a press processing (especially, a punching work) to the metal plate 30 formed of various materials in accordance with purposes such as an aluminum based material or a copper based material so as to form the positive electrode terminal side mounting hole 36 and the negative electrode terminal side metal member 37 (refer to FIG. 7A). Just after this step, an oxidizing film is not formed in the inner peripheral surfaces of the positive electrode terminal side mounting hole 36 and the negative electrode terminal side metal member 37.

The step of applying a press processing to the positive electrode terminal side thick plate formed of the same kind of metal as a metal of the positive electrode terminal 11 so as to form the positive electrode terminal side metal member 38 that has a diameter smaller than the positive electrode terminal side mounting hole 36 is particularly carried out to apply a press processing (especially, a punching work) to the positive electrode terminal side thick plate formed of aluminum or an aluminum alloy so as to form the positive electrode terminal side metal member 38 that becomes the positive electrode terminal connection part 13. The positive electrode terminal side thick plate has a thickness larger than the metal plate 30, thus the positive electrode terminal side metal member 38 has a thickness larger than the metal plate 30 similarly.

The step of applying a press processing to the negative electrode terminal side thick plate formed of the same kind of metal as a metal of the negative electrode terminal 12 so as to form the negative electrode terminal side metal member 39 that has a diameter smaller than the negative electrode terminal side mounting hole 37 is particularly carried out to apply a press processing (especially, a punching work) to the negative electrode terminal side thick plate formed of copper or a copper alloy so as to form the negative electrode terminal side metal member 39 that becomes the negative electrode terminal connection part 14. The negative electrode terminal side thick plate has a thickness larger than the metal plate 30, thus the negative electrode terminal side metal member 39 has a thickness larger than the metal plate 30 similarly.

The step of forming the positive electrode terminal side metal member 38 and the step of forming the negative electrode terminal side metal member 39 can be also carried out at the same time.

The step of inserting the positive electrode terminal side metal member 38 into the inside of the positive electrode terminal side mounting hole 36 and simultaneously crushing the positive electrode terminal side metal member 38 in the inside of the positive electrode terminal side mounting hole 36 so as to join the metal plate 30 and the positive electrode terminal side metal member 38 while expanding the positive electrode terminal side mounting hole 36, and inserting the negative electrode terminal side metal member 39 into the inside of the negative electrode terminal side mounting hole 37 and simultaneously crushing the negative electrode terminal side metal member 39 in the inside of the negative electrode terminal side mounting hole 37 so as to join the metal plate 30 and the negative electrode terminal side metal member 39 while expanding the negative electrode terminal side mounting hole 37 is particularly carried out to crush the positive electrode terminal side metal member 38 in the inside of the positive electrode terminal side mounting hole 36 and simultaneously crush the negative electrode terminal side metal member 39 in the inside of the negative electrode terminal side mounting hole 37 by a blanking punch of a press device (refer to FIGS. 7B and 7C).

At this time, the positive electrode terminal side metal member 38 is crushed, and is rolled so as to have a diameter larger than the inner diameter of the positive electrode terminal side mounting hole 36, in association with this, the positive electrode terminal side mounting hole 36 is expanded. As a result, even if an oxide film is slightly formed in the inner peripheral surface of the positive electrode terminal side mounting hole 36, the oxide film is broken just before the joining, and generation of a newly formed surface is accelerated so that diffusion joining can be carried out between a metal of the metal plate 30 and aluminum or the like of the positive electrode terminal side metal member 38.

Consequently, the metal of the metal plate 30 and aluminum or the like of the positive electrode terminal side metal member 38 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

Similarly, the negative electrode terminal side metal member 39 is crushed, and is rolled so as to have a diameter larger than the inner diameter of the negative electrode terminal side mounting hole 37, in association with this, the negative electrode terminal side mounting hole 37 is expanded. As a result, even if an oxide film is slightly formed in the inner peripheral surface of the negative electrode terminal side mounting hole 37, the oxide film is broken just before the joining, and generation of a newly formed surface is accelerated so that diffusion joining can be carried out between a metal of the metal plate 30 and copper or the like of the negative electrode terminal side metal member 39.

Consequently, the metal of the metal plate 30 and copper or the like of the negative electrode terminal side metal member 39 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

A press processing has a processing speed higher than the other processing method, thus the above-mentioned steps can be continuously carried out by a press device, thereby work and operation from the forming of the positive electrode terminal side mounting hole 36 to the joining of the metal plate 30 and the positive electrode terminal side metal member 38, and work and operation from the forming of the negative electrode terminal side mounting hole 37 to the metal plate 30 and the negative electrode terminal side metal member 39 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side metal member 38 and the negative electrode terminal side metal member 39 so as to form the positive electrode terminal fixing hole 17 and the negative electrode terminal fixing hole 18, so that the positive electrode terminal connection part 13 and the negative electrode terminal connection part 14 are formed (refer to FIG. 7D).

In these steps, a press processing is applied to the center part of the positive electrode terminal side metal member 38 to allow the positive electrode terminal side metal member 38 to remain in the inner peripheral part of the positive electrode terminal side mounting hole 36 so as to form the positive electrode terminal fixing hole 17, and simultaneously a press processing is applied to the center part of the negative electrode terminal side metal member 39 to allow the negative electrode terminal side metal member 39 to remain in the inner peripheral part of the negative electrode terminal side mounting hole 37 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and the positive electrode terminal side metal member 38 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and the negative electrode terminal side metal member 39 that are mutually formed of the same kind of metal are brought into contact with each other so that the joining of the mutually same kind of metal can be realized.

Further, when the positive electrode terminal fixing hole 17 and the negative electrode terminal fixing hole 18 are formed, in order to prevent the joining of mutually different kinds of metals, it is preferable that the metal plate 30 is not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the expansion type manufacturing method further includes the step of heating under an inert atmosphere after joining the metal plate 30 and the positive electrode terminal side metal member 38 and joining the metal plate 30 and the negative electrode terminal side metal member 39 (refer to FIG. 7E).

Thereby, diffusion joining between the metal of the metal plate 30 and aluminum or the like of the positive electrode terminal side metal member 38 and diffusion joining between the metal of the metal plate 30 and copper or the like of the negative electrode terminal side metal member 39 are sufficiently progressed so that joining strength can be further heightened.

As the inert atmosphere, a helium gas atmosphere or an argon gas atmosphere can be used. The heating temperature is controlled to a temperature not more than the melting point of the metal plate 30, the positive electrode terminal side metal member 38 and the negative electrode terminal side metal member 39 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal member 38 that is the same kind of metal as a metal of the positive electrode terminal 11, and the negative electrode terminal fixing hole 18 that comes into contact with the negative electrode terminal 12 is formed of the negative electrode terminal side metal member 39 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, the press-fitting type manufacturing method will be explained.

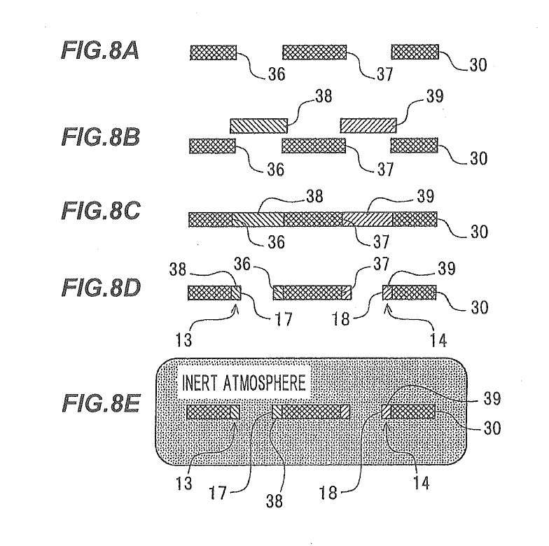

As shown in FIGS. 8A to 8E, the press-fitting type manufacturing method includes applying a press processing to the metal plate 30 so as to form the positive electrode terminal side mounting hole 36 and the negative electrode terminal side mounting hole 37, applying a press processing to a positive electrode terminal side plate member (not shown) formed of the same kind of metal as a metal of the positive electrode terminal 11 so as to form the positive electrode terminal side metal member 38 that has a diameter larger than the positive electrode terminal side mounting hole 36, applying a press processing to a negative electrode terminal side plate member (not shown) formed of the same kind of metal as a metal of the negative electrode terminal 12 so as to form the negative electrode terminal side metal member 39 that has a diameter larger than the negative electrode terminal side mounting hole 37, and press-fitting the positive electrode terminal side metal member 38 into the inside of the positive electrode terminal side mounting hole 36 so as to join the metal plate 30 and the positive electrode terminal side metal member 38, and press-fitting the negative electrode terminal side metal member 39 into the inside of the negative electrode terminal side mounting hole 37 so as to join the metal plate 30 and the negative electrode terminal side metal member 39.

Further, in FIGS. 8A to 8E, for convenience of explanation, a part of lines in the cross-sectional views is omitted.

Hereinafter, the respective steps will be concretely explained.

The step of applying a press processing to the metal plate 30 so as to form the positive electrode terminal side mounting hole 36 and the negative electrode terminal side mounting hole 37 is particularly carried out to apply a press processing (especially, a punching work) to the metal plate 30 formed of various materials in accordance with purposes such as an aluminum based material or a copper based material so as to form the positive electrode terminal side mounting hole 36 and the negative electrode terminal side mounting hole 37 (refer to FIG. 8A). Just after this step, an oxidizing film is not formed in the inner peripheral surfaces of the positive electrode terminal side mounting hole 36 and the negative electrode terminal side metal member 37.

The step of applying a press processing to the positive electrode terminal side plate member formed of the same kind of metal as a metal of the positive electrode terminal 11 so as to form the positive electrode terminal side metal member 38 that has a diameter larger than the positive electrode terminal side mounting hole 36 is particularly carried out to apply a press processing (especially, a punching work) to the positive electrode terminal side plate member formed of aluminum or an aluminum alloy so as to form the positive electrode terminal side metal member 38 that becomes the positive electrode terminal connection part 13. The positive electrode terminal side plate member has a thickness equal to the metal plate 30, thus the positive electrode terminal side metal member 38 has a thickness equal to the metal plate 30 similarly.

The step of applying a press processing to a negative electrode terminal side plate member (not shown) formed of the same kind of metal as a metal of the negative electrode terminal 12 so as to form the negative electrode terminal side metal member 39 that has a diameter larger than the negative electrode terminal side mounting hole 37 is particularly carried out to apply a press processing (especially, a punching work) to the negative electrode terminal side plate member formed of copper or a copper alloy so as to form the negative electrode terminal side metal member 39 that becomes the negative electrode terminal connection part 14. The negative electrode terminal side plate member has a thickness equal to the metal plate 30, thus the negative electrode terminal side metal member 39 has a thickness equal to the metal plate 30 similarly.

The step of forming the positive electrode terminal side metal member 38 and the step of forming the negative electrode terminal side metal member 39 can be also carried out at the same time.

The step of press-fitting the positive electrode terminal side metal member 38 into the inside of the positive electrode terminal side mounting hole 36 so as to join the metal plate 30 and the positive electrode terminal side metal member 38, and press-fitting the negative electrode terminal side metal member 39 into the inside of the negative electrode terminal side mounting hole 37 so as to join the metal plate 30 and the negative electrode terminal side metal member 39 is particularly carried out to press-fit the positive electrode terminal side metal member 38 into the inside of the positive electrode terminal side mounting hole 36, and simultaneously to press-fit the negative electrode terminal side metal member 39 into the inside of the negative electrode terminal side mounting hole 37 by a blanking punch of a press device (refer to FIGS. 8B and 8C).

At this time, the positive electrode terminal side metal member 38 and the positive electrode terminal side mounting hole 36 are brought into contact with each other so that the positive electrode terminal side metal member 38 is press-fitted into the inside of the positive electrode terminal side mounting hole 36 while being mutually scraped in their surfaces and performing plastic deformation. As a result, even if an oxide film is slightly formed in the inner peripheral surface of the positive electrode terminal side mounting hole 36, the oxide film is broken just before the joining, and generation of a newly formed surface is accelerated so that diffusion joining can be carried out between the metal of the metal plate 30 and aluminum or the like of the positive electrode terminal side metal member 38.

Consequently, the metal of the metal plate 30 and aluminum or the like of the positive electrode terminal side metal member 38 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

Similarly, the negative electrode terminal side metal member 39 and the negative electrode terminal side mounting hole 37 are brought into contact with each other so that the negative electrode terminal side metal member 39 is press-fitted into the inside of the negative electrode terminal side mounting hole 37 while being mutually scraped in their surfaces and performing plastic deformation. As a result, even if an oxide film is slightly formed in the inner peripheral surface of the negative electrode terminal side mounting hole 37, the oxide film is broken just before the joining, and generation of a newly formed surface is accelerated so that diffusion joining can be carried out between the metal of the metal plate 30 and copper or the like of the negative electrode terminal side metal member 39.

Consequently, the metal of the metal plate 30 and copper or the like of the positive electrode terminal side metal member 39 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

A press processing has a processing speed higher than the other processing method, thus the above-mentioned steps can be continuously carried out by a press device, thereby work and operation from the forming of the positive electrode terminal side mounting hole 36 to the joining of the metal plate 30 and the positive electrode terminal side metal member 38, and work and operation from the forming of the negative electrode terminal side mounting hole 37 to the metal plate 30 and the negative electrode terminal side metal member 39 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by press-fitting is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side metal member 38 and the negative electrode terminal side metal member 39 so as to form the positive electrode terminal fixing hole 17 and the negative electrode terminal fixing hole 18 and fabricate the positive electrode terminal connection part 13 and the negative electrode terminal connection part 14 (refer to FIG. 8D).

In the step, a press processing is applied to the center part of the positive electrode terminal side metal member 38 to allow the positive electrode terminal side metal member 38 to remain in the inner peripheral part of the positive electrode terminal side mounting hole 36 so as to form the positive electrode terminal fixing hole 17, and simultaneously a press processing is applied to the center part of the negative electrode terminal side metal member 39 to allow the negative electrode terminal side metal member 39 to remain in the inner peripheral part of the negative electrode terminal side mounting hole 37 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and the positive electrode terminal side metal member 38 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and the negative electrode terminal side metal member 39 that are mutually formed of the same kind of metal are brought into contact with each other, so that the joining of the mutually same kind of metal can be respectively realized.

Further, when the positive electrode terminal fixing hole 17 or the negative electrode terminal fixing hole 18 is formed, in order to prevent the joining of mutually different kinds of metals, it is preferable that the metal plate 30 is not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the press-fitting type manufacturing method further includes the step of heating under an inert atmosphere after joining the metal plate 30 and the positive electrode terminal side metal member 38 and joining the metal plate 30 and the negative electrode terminal side metal member 39 (refer to FIG. 8E).

Thereby, diffusion joining between the metal of the metal plate 30 and aluminum or the like of the positive electrode terminal side metal member 38, and diffusion joining between the metal of the metal plate 30 and copper or the like of the negative electrode terminal side metal member 39 are sufficiently progressed so that joining strength can be further heightened.

As the inert atmosphere, a helium gas atmosphere or an argon gas atmosphere can be used. The heating temperature is controlled to a temperature not more than the melting point of the metal plate 30, the positive electrode terminal side metal member 38 and the negative electrode terminal side metal member 39 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal member 38 that is the same kind of metal as a metal of the positive electrode terminal 11, and the negative electrode terminal fixing hole 18 that comes into contact with the negative electrode terminal 12 is formed of the negative electrode terminal side metal member 39 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, an operation and effect of the manufacturing method of the electrode terminal connection body of the second embodiment of the invention will be explained.

The electrode terminal connection bodies described in JP-2011-210482 A1 and JP-2012-89254 A1 are manufactured by forming an intermediate product in which mutually different kinds of metals are joined, by a hydrostatic extrusion processing, and applying to the intermediate product so as to obtain an electrode terminal connection body having a plate-like shape.

In order to carry out a hydrostatic extrusion processing, a large-scaled facility is needed, and in order to apply a cutting processing to the intermediate product so as to obtain an electrode terminal connection body having a plate-like shape, a long time is needed and simultaneously waste of chip is increased, thus it is estimated that production cost is extremely increased.

In addition, JP-2011-210482 A1 discloses that an electrode terminal connection body is manufactured by forming a mounting hole in a plate material and press-fitting a metal member formed of a different kind of metal into the mounting hole, but there is a risk that before the metal member is press-fitted into the mounting hole, an oxide film is grown on the surface of aluminum or an aluminum alloy so that sufficient joining strength cannot be obtained between mutually different kinds of metals.

On the other hand, in accordance with the manufacturing method of the electrode terminal connection body according to the second embodiment, the steps from the forming of the positive electrode terminal side mounting hole 36 and the negative electrode terminal side mounting hole 37 to the joining of the positive electrode terminal side metal member 38 and the negative electrode terminal side metal member 39 are carried out by a press processing that is excellent in a processing speed and can be operated by a small-scaled facility in comparison with a hydrostatic extrusion processing, so that a large-scaled facility is not needed and the steps from the forming of the positive electrode terminal side mounting hole 36 and the negative electrode terminal side mounting hole 37 to the joining of the positive electrode terminal side metal member 38 and the negative electrode terminal side metal member 39 can be carried out in a short time.

In addition, in the manufacturing method of the electrode terminal connection body, the processing speed of the steps from the forming of the positive electrode terminal side mounting hole 36 and the negative electrode terminal side mounting hole 37 to the joining of the positive electrode terminal side metal member 38 and the negative electrode terminal side metal member 39 is higher than that of a case of using a hydrostatic extrusion processing and/or a cutting processing together so that the growth of oxide film can be prevented during the processing.

Furthermore, in the manufacturing method of the electrode terminal connection body, when the positive electrode terminal side mounting hole 36 and the positive electrode terminal side metal member 38 are joined, and when the negative electrode terminal side mounting hole 37 and the negative electrode terminal side metal member 39 are joined, even if an oxide film is slightly formed in the inner peripheral surface of the positive electrode terminal side mounting hole 36 or the negative electrode terminal side mounting hole 37, just before the joining, the oxide film can be broken and diffusion joining can be applied to mutually different kinds of metals so that sufficient joining strength can be obtained between mutually different kinds of metals.

Namely, in accordance with the manufacturing method of the electrode terminal connection body according to the second embodiment, a large-scaled facility is not needed and the steps from the forming of the mounting hole to the joining of the metal member can be carried out in a short time, so that the electrode terminal connection body 10 can be obtained, the electrode terminal connection body 10 being capable of preventing the growth of oxide film to a minimum so as to be joined and realizing a sufficient joining strength between mutually different kinds of metals.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

The second embodiment is configured such that in the expansion type manufacturing method, all of the joinings are carried out by the expansion, and in the press-fitting type manufacturing method, all of the joinings are carried out by the press-fitting, but not limited to this, a combination of the joining by the expansion and the joining by the press-fitting may be also adopted.

As mentioned above, according to the second embodiment of the invention, an electrode terminal connection body and a manufacturing method of the electrode terminal connection body can be provided, the electrode terminal connection body being configured such that a main base material occupying most of the whole volume is free from limitation due to the metal of which the electrode terminal is formed, and materials having various characteristics can be freely used as the main base material.

Hereinafter, the preferred third embodiment according to the invention will be explained below referring to the drawings.

First, an electrode terminal connection body will be explained.

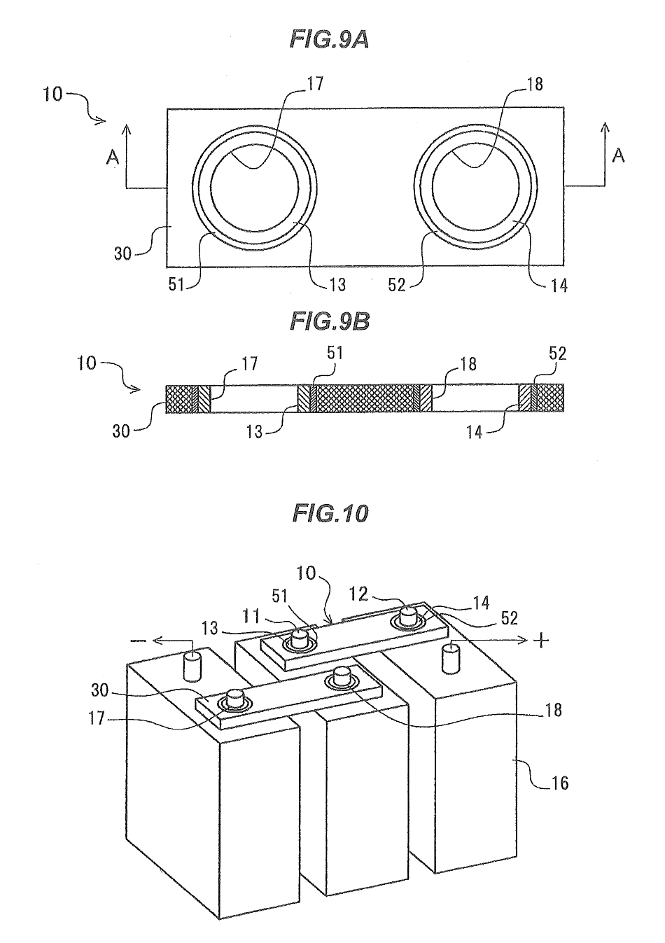

As shown in FIGS. 9A, 9B and FIG. 10, the electrode terminal connection body 10 according to the third embodiment is configured to electrically connect a positive electrode terminal 11 and a negative electrode terminal 12 that are formed of mutually different kinds of metals, and includes a metal plate 30, a positive electrode terminal connection part 13 disposed in a part of the metal plate 30 and formed of the same kind of metal as a metal of the positive electrode terminal 11 and a negative electrode terminal connection part 14 disposed in a part of the metal plate 30 and formed of the same kind of metal as a metal of the negative electrode terminal 12, wherein the positive electrode terminal connection part 13 and the metal plate 30 are connected via a positive electrode terminal side interposing part 51 formed of a metal that has an ionization tendency between the metal of the positive electrode terminal 11 and the metal of the metal plate 30, and the negative electrode terminal connection part 14 and the metal plate 30 are connected via a negative electrode terminal side interposing part 52 formed of a metal that has an ionization tendency between the metal of the negative electrode terminal 12 and the metal of the metal plate 30.

The positive electrode terminal 11 and the negative electrode terminal 12 are respectively formed so as to extend from the nonaqueous electrolyte secondary battery 16.

The positive electrode terminal 11 is comprised of aluminum or an aluminum alloy, and the negative electrode terminal 12 is comprised of copper or a copper alloy.

A plurality of the nonaqueous electrolyte secondary batteries 16 are connected in series-parallel via the electrode terminal connection body 10, for example, constitutes a battery system that is mounted in an electric car and a hybrid car as a motive power thereof.

It is preferable that the metal plate 30 is comprised of an aluminum based material or a copper based material. This is because the aluminum based material is selected as a material of the metal plate 30, thereby a weight reduction of the electrode terminal connection body 10 can be realized, in addition, the copper based material is selected as a material of the metal plate 30, thereby a resistance reduction of the electrode terminal connection body 10 can be realized (conductivity thereof can be heightened).

A specific embodiment of the aluminum based material includes pure aluminum, and a specific embodiment of the copper based material includes tough pitch copper, oxygen free copper and the like.

Further, a configuration that a material of the metal plate 30 is formed of the same kind of material as a material of the positive electrode terminal connection part 13 or the negative electrode terminal connection part 14 shall not be excluded.

The positive electrode terminal connection part 13 is a part that is configured to be electrically connected to the positive electrode terminal 11 and the negative electrode terminal connection part 14 is a part that is configured to be electrically connected to the negative electrode terminal 12.

In the positive electrode terminal connection part 13, a positive electrode terminal fixing hole 17 is formed, the positive electrode terminal fixing hole 17 being configured such that the positive electrode terminal 11 is inserted therein so as to be fixed by resistance welding or the like, and in the negative electrode terminal connection part 14, a negative electrode terminal fixing hole 18 is formed, the negative electrode terminal fixing hole 18 being configured such that the negative electrode terminal 12 is inserted therein so as to be fixed by resistance welding or the like.

The positive electrode terminal side interposing part 51 is configured to prevent an occurrence of corrosion and increase in resistance in the joining part of the positive electrode terminal connection part 13 and the metal plate 30, and the negative electrode terminal side interposing part 52 is configured to prevent an occurrence of corrosion and increase in resistance in the joining part of the negative electrode terminal connection part 14 and the metal plate 30.

Here, metals of the positive electrode terminal side interposing part 51 and the negative electrode terminal side interposing part 52 are selected based on an ionization tendency, but a configuration using a base other than the ionization tendency can be adopted, that a metal having a standard electrode potential located between the metal of the positive electrode terminal 11 and the metal of the metal plate 30 is selected as the metal of the positive electrode terminal side interposing part 51, and a metal having a standard electrode potential located between the metal of the negative electrode terminal 12 and the metal of the metal plate 30 is selected as the metal of the negative electrode terminal side interposing part 52. Because an ionization permutation exhibiting the ionization tendency corresponds to electrochemical series exhibiting the standard electrode potential that is represented by using hydrogen as a standard electrode.

In accordance with the electrode terminal connection body 10 according to the third embodiment, the main base material that occupies most of the whole volume is formed of the metal plate 30, thus a material of the metal plate 30 is changed in accordance with purposes, thereby materials having various characteristics can be freely used as the main base material.

In addition, the electrode terminal connection body 10 is configured such that the positive electrode terminal connection part 13 and the negative electrode terminal connection part 14 that are formed of a material different from that of the metal plate 30 are disposed in only a part of the metal plate 30, thus material characteristics of the positive electrode terminal connection part 13 and the negative electrode terminal connection part 14 exert an extremely small influence on the whole characteristics of the electrode terminal connection body 10 so that characteristics of the electrode terminal connection body 10 can be freely designed by selecting a material of the metal plate 30.

Furthermore, the positive electrode terminal connection part 13 and the metal plate 30 are connected via the positive electrode terminal side interposing part 51 formed of a metal that has an ionization tendency between the metal of the positive electrode terminal 11 and the metal of the metal plate 30, and the negative electrode terminal connection part 14 and the metal plate 30 are connected via the negative electrode terminal side interposing part 52 formed of a metal that has an ionization tendency between the metal of the negative electrode terminal 12 and the metal of the metal plate 30, thus the change of not only the ionization tendency in the connection interface between the positive electrode terminal connection part 13 and the metal plate 30, and the connection interface between the negative electrode terminal connection part 14 and the metal plate 30, but also the electric potential difference of the standard electrode potential in the connection interface can be reduced, and an occurrence of corrosion and increase in resistance in the joining part of the electrode terminal connection body 10 due to a local battery effect can be prevented.

Next, a manufacturing method of the electrode terminal connection body will be explained. In the manufacturing method of the electrode terminal connection body, an expansion type manufacturing method and a press-fitting type manufacturing method are mainly included, thus these manufacturing methods will be explained in order.

First, the expansion type manufacturing method will be explained.

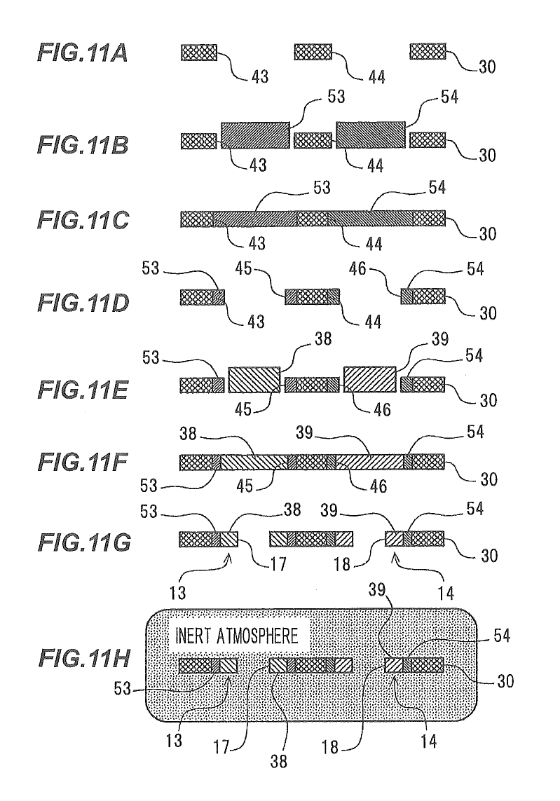

As shown in FIGS. 11A to 11H, the expansion type manufacturing method includes applying a press processing to the metal plate 30 so as to form a first positive electrode terminal side mounting hole 43 and a first negative electrode terminal side mounting hole 44, applying a press processing to a positive electrode terminal side interposing thick plate (not shown) formed of a metal that has an ionization tendency between the metal of the positive electrode terminal 11 and the metal of the metal plate 30 so as to form a positive electrode terminal side interposing metal member 53 that has a diameter smaller than the first positive electrode terminal side mounting hole 43, applying a press processing to a negative electrode terminal side interposing thick plate (not shown) formed of a metal that has an ionization tendency between the metal of the negative electrode terminal 12 and the metal of the metal plate 30 so as to form a negative electrode terminal side interposing metal member 54 that has a diameter smaller than the first negative electrode terminal side mounting hole 44, inserting the positive electrode terminal side interposing metal member 53 into the inside of the first positive electrode terminal side mounting hole 43 and simultaneously crushing the positive electrode terminal side imposing metal member 53 in the inside of the first positive electrode terminal side mounting hole 43 so as to join the metal plate 30 and the positive electrode terminal side interposing metal member 53 while expanding the first positive electrode terminal side mounting hole 43, and inserting the negative electrode terminal side interposing metal member 54 into the inside of the first negative electrode terminal side mounting hole 44 and simultaneously crushing the negative electrode terminal side imposing metal member 54 in the inside of the first negative electrode terminal side mounting hole 44 so as to join the metal plate 30 and the negative electrode terminal side interposing metal member 54 while expanding the first negative electrode terminal side mounting hole 44, applying a press processing to the center part of the positive electrode terminal side interposing metal member 53 to allow the positive electrode terminal side interposing metal member 53 to remain in the inner peripheral part of the first positive electrode terminal side mounting hole 43 so as to form a second positive electrode terminal mounting hole 45, and applying a press processing to the center part of the negative electrode terminal side interposing metal member 54 to allow the negative electrode terminal side interposing metal member 54 to remain in the inner peripheral part of the first negative electrode terminal side mounting hole 44 so as to form a second negative electrode terminal mounting hole 46, applying a press processing to a positive electrode terminal side thick plate (not shown) formed of the same kind of metal as a metal of the positive electrode terminal 11 so as to form a positive electrode terminal side metal member 38 that has a diameter smaller than the second positive electrode terminal side mounting hole 45, applying a press processing to a negative electrode terminal side thick plate (not shown) formed of the same kind of metal as a metal of the negative electrode terminal 12 so as to form a negative electrode terminal side metal member 39 that has a diameter smaller than the second negative electrode terminal side mounting hole 46, and inserting the positive electrode terminal side metal member 38 into the second inside of the positive electrode terminal side mounting hole 45 and simultaneously crushing the positive electrode terminal side metal member 38 in the inside of the second positive electrode terminal side mounting hole 45 so as to join the positive electrode terminal side interposing metal member 53 and the positive electrode terminal side metal member 38 while expanding the second positive electrode terminal side mounting hole 45, and inserting the negative electrode terminal side metal member 39 into the inside of the second negative electrode terminal side mounting hole 46 and simultaneously crushing the negative electrode terminal side metal member 39 in the inside of the second negative electrode terminal side mounting hole 46 so as to join the negative electrode terminal side interposing metal member 54 and the negative electrode terminal side metal member 39 while expanding the second negative electrode terminal side mounting hole 46.

Further, in FIGS. 11A to 11H for convenience of explanation, a part of lines in the cross-sectional views is omitted.

Hereinafter, the respective steps will be concretely explained.

The step of applying a press processing to a metal plate 30 so as to form the first positive electrode terminal side mounting hole 43 and the first negative electrode terminal side mounting hole 44 is particularly carried out to apply a press processing (especially, a punching work) to the metal plate 30 formed of various materials in accordance with purposes such as an aluminum based material or a copper based material so as to form the first positive electrode terminal side mounting hole 43 and the first negative electrode terminal side mounting hole 44 (refer to FIG. 11A). Just after this step, an oxidizing film is not formed in the inner peripheral surfaces of the positive electrode terminal side mounting hole 36 and the negative electrode terminal side mounting hole 37.

The step of applying a press processing to a positive electrode terminal side interposing thick plate formed of a metal that has an ionization tendency between the metal of the positive electrode terminal 11 and the metal of the metal plate 30 so as to form a positive electrode terminal side interposing metal member 53 that has a diameter smaller than the first positive electrode terminal side mounting hole 43 is particularly carried out to apply a press processing (especially, a punching work) to the positive electrode terminal side interposing thick plate so as to form the positive electrode terminal side interposing metal member 53 that becomes the positive electrode terminal side interposing part 51. The positive electrode terminal side interposing thick plate has a thickness larger than the metal plate 30, thus the positive electrode terminal side interposing metal member 53 has a thickness larger than the metal plate 30 similarly.

The step of applying a press processing to the negative electrode terminal side interposing thick plate formed of a metal that has an ionization tendency between the metal of the negative electrode terminal 12 and the metal of the metal plate 30 so as to form a negative electrode terminal side interposing metal member 54 that has a diameter smaller than the first negative electrode terminal side mounting hole 44 is particularly carried out to applying a press processing (especially, a punching work) to the negative electrode terminal side interposing thick plate so as to form the negative electrode terminal side interposing metal member 54 that becomes the negative electrode terminal side interposing part 52. The negative electrode terminal side interposing thick plate has a thickness larger than the metal plate 30, thus the negative electrode terminal side interposing metal member 54 has a thickness larger than the metal plate 30 similarly.

Here, metals of the positive electrode terminal side interposing thick plate and the negative electrode terminal side interposing thick plate are selected based on an ionization tendency, but a configuration using a base other than the ionization tendency can be adopted, that a metal having a standard electrode potential located between the metal of the positive electrode terminal 11 and the metal of the metal plate 30 is selected as the metal of the positive electrode terminal side interposing thick plate, and a metal having a standard electrode potential located between the metal of the negative electrode terminal 12 and the metal of the metal plate 30 is selected as the metal of the negative electrode terminal side interposing thick plate. The reason is that an ionization permutation exhibiting the ionization tendency corresponds to electrochemical series exhibiting the standard electrode potential that is represented by using hydrogen as a standard electrode.

The step of forming the positive electrode terminal side interposing metal member 53 and the step of forming the negative electrode terminal side interposing metal member 54 can be also carried out at the same time.

The step of inserting the positive electrode terminal side interposing metal member 53 into the inside of the first positive electrode terminal side mounting hole 43 and simultaneously crushing the positive electrode terminal side imposing metal member 53 in the inside of the first positive electrode terminal side mounting hole 43 so as to join the metal plate 30 and the positive electrode terminal side interposing metal member 53 while expanding the first positive electrode terminal side mounting hole 43, and inserting the negative electrode terminal side interposing metal member 54 into the inside of the first negative electrode terminal side mounting hole 44 and simultaneously crushing the negative electrode terminal side imposing metal member 54 in the inside of the first negative electrode terminal side mounting hole 44 so as to join the metal plate 30 and the negative electrode terminal side interposing metal member 54 while expanding the first negative electrode terminal side mounting hole 44 is particularly carried out to crush the positive electrode terminal side imposing metal member 53 in the inside of the first positive electrode terminal side mounting hole 43 and simultaneously crush the negative electrode terminal side imposing metal member 54 in the inside of the first positive electrode terminal side mounting hole 44 by a blanking punch of a press device (refer to FIGS. 11B and 11C).

At this time, the positive electrode terminal side interposing metal member 53 is crushed, and is rolled so as to have a diameter larger than the inner diameter of the first positive electrode terminal side mounting hole 43, in association with this, the first positive electrode terminal side mounting hole 43 is expanded. As a result, even if an oxide film is slightly formed in the inner peripheral surface of the first positive electrode terminal side mounting hole 43, the oxide film is broken just before the joining, and generation of a newly formed surface is accelerated so that diffusion joining can be carried out between a metal of the metal plate 30 and a metal of the positive electrode terminal side interposing metal member 53.

Consequently, the metal of the metal plate 30 and the metal of the positive electrode terminal side interposing metal member 53 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 30 and the metal of the positive electrode terminal side interposing metal member 53 have the respective ionization tendencies being close together, thus even if these mutually different kinds of metals are joined, in principle, corrosion and increase in resistance by a local battery effect is hard to occur.

Similarly, the negative electrode terminal side interposing metal member 54 is crushed, and is rolled so as to have a diameter larger than the inner diameter of the first negative electrode terminal side mounting hole 44, in association with this, the first negative electrode terminal side mounting hole 44 is expanded. As a result, even if an oxide film is slightly formed in the inner peripheral surface of the first negative electrode terminal side mounting hole 44, the oxide film is broken just before the joining, and generation of a newly formed surface is accelerated so that diffusion joining can be carried out between a metal of the metal plate 30 and a metal of the negative electrode terminal side interposing metal member 54.

Consequently, the metal of the metal plate 30 and the metal of the negative electrode terminal side interposing metal member 54 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 30 and the metal of the negative electrode terminal side interposing metal member 54 have the respective ionization tendencies being close together, thus even if these mutually different kinds of metals are joined, in principle, corrosion and increase in resistance by a local battery effect is hard to occur.

The step of applying a press processing to the center part of the positive electrode terminal side interposing metal member 53 to allow the positive electrode terminal side interposing metal member 53 to remain in the inner peripheral part of the first positive electrode terminal side mounting hole 43 so as to form a second positive electrode terminal mounting hole 45, and applying a press processing to the center part of the negative electrode terminal side interposing metal member 54 to allow the negative electrode terminal side interposing metal member 54 to remain in the inner peripheral part of the first negative electrode terminal side mounting hole 44 so as to form a second negative electrode terminal mounting hole 46 is particularly carried out to apply a press processing (especially, a punching work) to the positive electrode terminal side interposing metal member 53 so as to allow the positive electrode terminal side interposing metal member 53 to remain over the entire inner periphery of the first positive electrode terminal side mounting hole 43 in a sufficient thickness in the diameter direction, and simultaneously apply a press processing (especially, a punching work) to the negative electrode terminal side interposing metal member 54 so as to allow the negative electrode terminal side interposing metal member 54 to remain over the entire inner periphery of the first negative electrode terminal side mounting hole 44 in a sufficient thickness in the diameter direction (refer to FIG. 11D).

Thereby, in a post process, when the positive electrode terminal side metal member 38 is inserted into the second positive electrode terminal side mounting hole 45 so as to join the positive electrode terminal side interposing metal member 53 and the positive electrode terminal side metal member 38, and when the negative electrode terminal side metal member 39 is inserted into the second negative electrode terminal side mounting hole 46 so as to join the negative electrode terminal side interposing metal member 54 and the negative electrode terminal side metal member 39, mutually different kinds of metals that have the respective ionization tendencies being close together, are joined, thus an occurrence of corrosion and increase in resistance by a local battery effect can be effectively prevented.

The step of applying a press processing to a positive electrode terminal side thick plate formed of the same kind of metal as a metal of the positive electrode terminal 11 so as to form a positive electrode terminal side metal member 38 that has a diameter smaller than the second positive electrode terminal side mounting hole 45 is particularly carried out to apply a press processing (especially, a punching work) to the positive electrode terminal side thick plate formed of aluminum or an aluminum alloy so as to form the positive electrode terminal side metal member 38 that becomes the positive electrode terminal connection part 13. The positive electrode terminal side thick plate has a thickness equal to the metal plate 30, thus the positive electrode terminal side metal member 38 has a thickness equal to the metal plate 30 similarly.

The step of applying a press processing to a negative electrode terminal side thick plate formed of the same kind of metal as a metal of the negative electrode terminal 12 so as to form the negative electrode terminal side metal member 39 that has a diameter smaller than the second negative electrode terminal side mounting hole 46 is particularly carried out to apply a press processing (especially, a punching work) to the negative electrode terminal side thick plate formed of copper or a copper alloy so as to form the negative electrode terminal side metal member 39 that becomes the negative electrode terminal connection part 14. The negative electrode terminal side thick plate has a thickness equal to the metal plate 30, thus the negative electrode terminal side metal member 39 has a thickness equal to the metal plate 30 similarly.

The step of forming the positive electrode terminal side metal member 38 and the step of forming the negative electrode terminal side metal member 39 can be also carried out at the same time.

The step of inserting the positive electrode terminal side metal member 38 into the second inside of the positive electrode terminal side mounting hole 45 and simultaneously crushing the positive electrode terminal side metal member 38 in the inside of the second positive electrode terminal side mounting hole 45 so as to join the positive electrode terminal side interposing metal member 53 and the positive electrode terminal side metal member 38 while expanding the second positive electrode terminal side mounting hole 45, and inserting the negative electrode terminal side metal member 39 into the inside of the second negative electrode terminal side mounting hole 46 and simultaneously crushing the negative electrode terminal side metal member 39 in the inside of the second negative electrode terminal side mounting hole 46 so as to join the negative electrode terminal side interposing metal member 54 and the negative electrode terminal side metal member 39 while expanding the second negative electrode terminal side mounting hole 46 is particularly carried out to crush the positive electrode terminal side metal member 38 in the inside of the first positive electrode terminal side mounting hole 43 and simultaneously crush the negative electrode terminal side metal member 39 in the inside of the first negative electrode terminal side mounting hole 44 by a blanking punch of a press device (refer to FIGS. 11E and 11F).

At this time, the positive electrode terminal side metal member 38 is crushed, and is rolled so as to have a diameter larger than the inner diameter of the second positive electrode terminal side mounting hole 45, in association with this, the second positive electrode terminal side mounting hole 45 is expanded. As a result, even if an oxide film is slightly formed in the inner peripheral surface of the second positive electrode terminal side mounting hole 45, the oxide film is broken just before the joining, and generation of a newly formed surface is accelerated so that diffusion joining can be carried out between a metal of the positive electrode terminal side interposing metal member 53 and aluminum or the like of the positive electrode terminal side metal member 38.

Consequently, the metal of the positive electrode terminal side interposing metal member 53 and aluminum or the like of the positive electrode terminal side metal member 38 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the positive electrode terminal side interposing metal member 53 and aluminum or the like of the positive electrode terminal side metal member 38 have the respective ionization tendencies being close together, thus even if these mutually different kinds of metals are joined, in principle, corrosion and increase in resistance by a local battery effect is hard to occur.

Similarly, the negative electrode terminal side metal member 39 is crushed, and is rolled so as to have a diameter larger than the inner diameter of the second negative electrode terminal side mounting hole 46, in association with this, the second negative electrode terminal side mounting hole 46 is expanded. As a result, even if an oxide film is slightly formed in the inner peripheral surface of the second negative electrode terminal side mounting hole 46, the oxide film is broken just before the joining, and generation of a newly formed surface is accelerated so that diffusion joining can be carried out between a metal of the negative electrode terminal side interposing metal member 54 and a metal of the negative electrode terminal side metal member 39.

Consequently, the metal of the negative electrode terminal side interposing metal member 54 and copper or the like of the negative electrode terminal side metal member 39 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the negative electrode terminal side interposing metal member 54 and copper or the like of the positive electrode terminal side metal member 39 have the respective ionization tendencies being close together, thus even if these mutually different kinds of metals are joined, in principle, corrosion and increase in resistance by a local battery effect is hard to occur.

A press processing has a processing speed higher than the other processing method, thus the above-mentioned steps can be continuously carried out by a press device, thereby work and operation from the forming of the first positive electrode terminal side mounting hole 43 to the joining of the metal plate 30 and the positive electrode terminal side interposing metal member 53 and work and operation from the forming of the first negative electrode terminal side mounting hole 44 to the metal plate 30 and the negative electrode terminal side interposing metal member 54, and further work and operation from the forming of the second positive electrode terminal side mounting hole 45 to the joining of the positive electrode terminal side interposing metal member 53 and the positive electrode terminal side metal member 38 and work and operation from the forming of the second negative electrode terminal side mounting hole 46 to the negative electrode terminal side interposing metal member 54 and the negative electrode terminal side metal member 39 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side metal member 38 and the negative electrode terminal side metal member 39 so as to form the positive electrode terminal fixing hole 17 and the negative electrode terminal fixing hole 18, so that the positive electrode terminal connection part 13 and the negative electrode terminal connection part 14 are formed (refer to FIG. 11G).

In the step, a press processing is applied to the center part of the positive electrode terminal side metal member 38 to allow the positive electrode terminal side metal member 38 to remain in the inner peripheral part of the second positive electrode terminal side mounting hole 45 so as to form the positive electrode terminal fixing hole 17, and simultaneously a press processing is applied to the center part of the negative electrode terminal side metal member 39 to allow the negative electrode terminal side metal member 39 to remain in the inner peripheral part of the second negative electrode terminal side mounting hole 46 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and the positive electrode terminal side metal member 38 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and the negative electrode terminal side metal member 39 that are mutually formed of the same kind of metal are brought into contact with each other so that the joining of the mutually same kind of metal can be realized.

Further, when the positive electrode terminal fixing hole 17 and the negative electrode terminal fixing hole 18 are formed, in order to prevent the joining of mutually different kinds of metals, it is preferable that the positive electrode terminal side interposing metal member 53 and the negative electrode terminal side interposing metal member 54 are not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the expansion type manufacturing method further includes the step of heating under an inert atmosphere after joining the positive electrode terminal side interposing metal member 53 and the positive electrode terminal side metal member 38 and joining the negative electrode terminal side interposing metal member 54 and the negative electrode terminal side metal member 39 (refer to FIG. 11H).

Thereby, diffusion joining between the metal of the metal plate 30 and the metal of the positive electrode terminal side interposing metal member 53, diffusion joining between the metal of the positive electrode terminal side interposing metal member 53 and aluminum or the like of the positive electrode terminal side metal member 38, diffusion joining between the metal of the metal plate 30 and the metal of the negative electrode terminal side interposing metal member 54 and diffusion joining between the metal of the negative electrode terminal side interposing metal member 54 and copper or the like of the negative electrode terminal side metal member 39 are sufficiently progressed so that joining strength can be further heightened.

As the inert atmosphere, a helium gas atmosphere or an argon gas atmosphere can be used. The heating temperature is controlled to a temperature not more than the melting point of the metal plate 30, the positive electrode terminal side interposing metal member 53, the negative electrode terminal side interposing metal member 54, the positive electrode terminal side metal member 38 and the negative electrode terminal side metal member 39 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal member 38 that is the same kind of metal as a metal of the positive electrode terminal 11, and the negative electrode terminal fixing hole 18 that comes into contact with the negative electrode terminal 12 is formed of the negative electrode terminal side metal member 39 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, the press-fitting type manufacturing method will be explained.

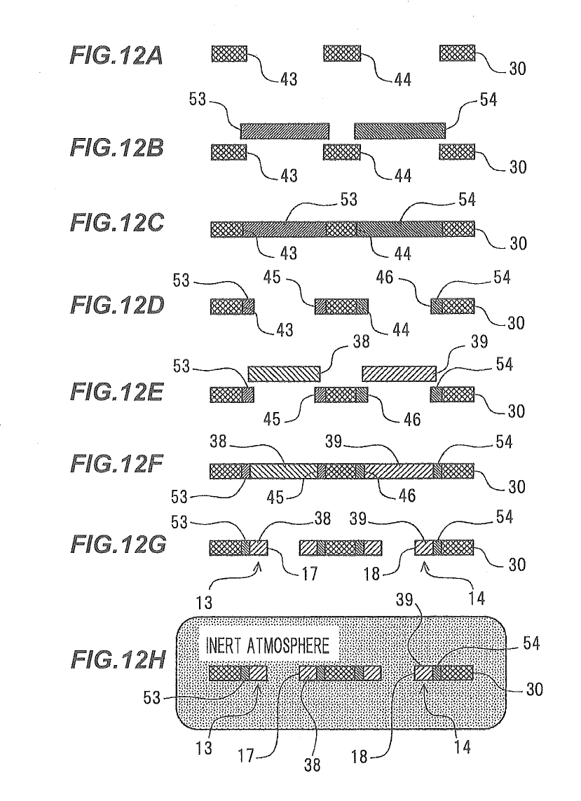

As shown in FIGS. 12A to 12H, the press-fitting type manufacturing method includes applying a press processing to the metal plate 30 so as to form the first positive electrode terminal side mounting hole 43 and the first negative electrode terminal side mounting hole 44, applying a press processing to a positive electrode terminal side interposing plate member (not shown) formed of a metal that has an ionization tendency between the metal of the positive electrode terminal 11 and the metal of the metal plate 30 so as to form the positive electrode terminal side interposing metal member 53 that has a diameter larger than the first positive electrode terminal side mounting hole 43, applying a press processing to a negative electrode terminal side interposing plate member (not shown) formed of a metal that has an ionization tendency between the metal of the negative electrode terminal 12 and the metal of the metal plate 30 so as to form the negative electrode terminal side interposing metal member 54 that has a diameter larger than the first negative electrode terminal side mounting hole 44, press-fitting the positive electrode terminal side interposing metal member 53 into the inside of the first positive electrode terminal side mounting hole 43 so as to join the metal plate 30 and the positive electrode terminal side interposing metal member 53, and press-fitting the negative electrode terminal side interposing metal member 54 into the inside of the first negative electrode terminal side mounting hole 44 so as to join the metal plate 30 and the negative electrode terminal side interposing metal member 54, applying a press processing to the center part of the positive electrode terminal side interposing metal member 53 to allow the positive electrode terminal side interposing metal member 53 to remain in the inner peripheral part of the first positive electrode terminal side mounting hole 43 so as to form the second positive electrode terminal mounting hole 45, and applying a press processing to the center part of the negative electrode terminal side interposing metal member 54 to allow the negative electrode terminal side interposing metal member 54 to remain in the inner peripheral part of the first negative electrode terminal side mounting hole 44 so as to form the second negative electrode terminal mounting hole 46, applying a press processing to a positive electrode terminal side plate member (not shown) formed of the same kind of metal as a metal of the positive electrode terminal 11 so as to form the positive electrode terminal side metal member 38 that has a diameter larger than the second positive electrode terminal side mounting hole 45 applying a press processing to a negative electrode terminal side plate member (not shown) formed of the same kind of metal as a metal of the negative electrode terminal 12 so as to form the negative electrode terminal side metal member 39 that has a diameter larger than the second negative electrode terminal side mounting hole 46, and press-fitting the positive electrode terminal side metal member 38 into the inside of the second positive electrode terminal side mounting hole 45 so as to join the positive electrode terminal side interposing metal member 53 and the positive electrode terminal side metal member 38, and press-fitting the negative electrode terminal side metal member 39 into the inside of the second negative electrode terminal side mounting hole 46 so as to join the negative electrode terminal side interposing metal member 54 and the negative electrode terminal side metal member 39.

Further, in FIGS. 11A to 11H, for convenience of explanation, a part of lines in the cross-sectional views is omitted.

Hereinafter, the respective steps will be concretely explained.

The step of applying a press processing to the metal plate 30 so as to form the first positive electrode terminal side mounting hole 43 and the first negative electrode terminal side mounting hole 44 is particularly carried out to apply a press processing (especially, a punching work) to the metal plate 30 formed of various materials in accordance with purposes such as an aluminum based material or a copper based material so as to form the first positive electrode terminal side mounting hole 43 and the first negative electrode terminal side mounting hole 44 (refer to FIG. 12A). Just after this step, an oxidizing film is not formed in the inner peripheral surfaces of the first positive electrode terminal side mounting hole 43 and the first negative electrode terminal side mounting hole 44.

The step of applying a press processing to a positive electrode terminal side interposing plate member (not shown) formed of a metal that has an ionization tendency between the metal of the positive electrode terminal 11 and the metal of the metal plate 30 so as to form the positive electrode terminal side interposing metal member 53 that has a diameter larger than the first positive electrode terminal side mounting hole 43 is particularly carried out to apply a press processing (especially, a punching work) to the positive electrode terminal side interposing metal member 53 that becomes the positive electrode terminal side interposing part 51. The positive electrode terminal side interposing plate member has a thickness equal to the metal plate 30, thus the positive electrode terminal side interposing metal member 53 has a thickness equal to the metal plate 30 similarly.

The step of applying a press processing to a negative electrode terminal side interposing plate member (not shown) formed of a metal that has an ionization tendency between the metal of the negative electrode terminal 12 and the metal of the metal plate 30 so as to form the negative electrode terminal side interposing metal member 54 that has a diameter larger than the first negative electrode terminal side mounting hole 44 is particularly carried out to apply a press processing (especially, a punching work) to the negative electrode terminal side interposing metal member 54 that becomes the negative electrode terminal side interposing part 52. The negative electrode terminal side interposing plate member has a thickness equal to the metal plate 30, thus the negative electrode terminal side interposing metal member 54 has a thickness equal to the metal plate 30 similarly.

Here, metals of the positive electrode terminal side interposing plate member and the negative electrode terminal side interposing plate member are selected based on an ionization tendency, but a configuration using a base other than the ionization tendency can be adopted, that a metal having a standard electrode potential located between the metal of the positive electrode terminal 11 and the metal of the metal plate 30 is selected as the metal of the positive electrode terminal side interposing plate member, and a metal having a standard electrode potential located between the metal of the negative electrode terminal 12 and the metal of the metal plate 30 is selected as the metal of the negative electrode terminal side interposing plate member. The reason is that an ionization permutation exhibiting the ionization tendency corresponds to electrochemical series exhibiting the standard electrode potential that is represented by using hydrogen as a standard electrode.

The step of forming the positive electrode terminal side interposing metal member 53 and the step of forming the negative electrode terminal side interposing metal member 54 can be also carried out at the same time.

The step of press-fitting the positive electrode terminal side interposing metal member 53 into the inside of the first positive electrode terminal side mounting hole 43 so as to join the metal plate 30 and the positive electrode terminal side interposing metal member 53, and press-fitting the negative electrode terminal side interposing metal member 54 into the inside of the first negative electrode terminal side mounting hole 44 so as to join the metal plate 30 and the negative electrode terminal side interposing metal member 54 is particularly carried out to press-fit the positive electrode terminal side interposing metal member 53 into the inside of the first positive electrode terminal side mounting hole 43, and simultaneously to press-fit the negative electrode terminal side interposing metal member 54 into the inside of the first negative electrode terminal side mounting hole 44 by a blanking punch of a press device (refer to FIGS. 12B and 12C).

At this time, the positive electrode terminal side interposing metal member 53 and the first positive electrode terminal side mounting hole 43 are brought into contact with each other so that the positive electrode terminal side interposing metal member 53 is press-fitted into the inside of the first positive electrode terminal side mounting hole 43 while being mutually scraped in their surfaces and performing plastic deformation. As a result, even if an oxide film is slightly formed in the inner peripheral surface of the first positive electrode terminal side mounting hole 43, the oxide film is broken just before the joining, and generation of a newly formed surface is accelerated so that diffusion joining can be carried out between the metal of the metal plate 30 and the metal of the positive electrode terminal side interposing metal member 53.

Consequently, the metal of the metal plate 30 and the metal of the positive electrode terminal side interposing metal member 53 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 30 and the metal of the positive electrode terminal side interposing metal member 53 have the respective ionization tendencies being close together, thus even if these mutually different kinds of metals are joined, in principle, corrosion and increase in resistance by a local battery effect is hard to occur.

Similarly, the negative electrode terminal side interposing metal member 54 and the first negative electrode terminal side mounting hole 44 are brought into contact with each other so that the negative electrode terminal side interposing metal member 54 is press-fitted into the inside of the first negative electrode terminal side mounting hole 44 while being mutually scraped in their surfaces and performing plastic deformation. As a result, even if an oxide film is slightly formed in the inner peripheral surface of the first negative electrode terminal side mounting hole 44, the oxide film is broken just before the joining, and generation of a newly formed surface is accelerated so that diffusion joining can be carried out between the metal of the metal plate 30 and the metal of the negative electrode terminal side interposing metal member 54.

Consequently, the metal of the metal plate 30 and the metal of the negative electrode terminal side interposing metal member 54 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the metal plate 30 and the metal of the negative electrode terminal side interposing metal member 54 have the respective ionization tendencies being close together, thus even if these mutually different kinds of metals are joined, in principle, corrosion and increase in resistance by a local battery effect is hard to occur.

The step of applying a press processing to the center part of the positive electrode terminal side interposing metal member 53 to allow the positive electrode terminal side interposing metal member 53 to remain in the inner peripheral part of the first positive electrode terminal side mounting hole 43 so as to form the second positive electrode terminal mounting hole 45, and applying a press processing to the center part of the negative electrode terminal side interposing metal member 54 to allow the negative electrode terminal side interposing metal member 54 to remain in the inner peripheral part of the first negative electrode terminal side mounting hole 44 so as to form the second negative electrode terminal mounting hole 46 is particularly carried out to apply a press processing (especially, a punching work) to the positive electrode terminal side interposing metal member 53 so as to allow the positive electrode terminal side interposing metal member 53 to remain over the entire inner periphery of the first positive electrode terminal side mounting hole 43 in a sufficient thickness in the diameter direction, and simultaneously apply a press processing (especially, a punching work) to the negative electrode terminal side interposing metal member 54 so as to allow the negative electrode terminal side interposing metal member 54 to remain over the entire inner periphery of the first negative electrode terminal side mounting hole 44 in a sufficient thickness in the diameter direction (refer to FIG. 12D).

Thereby, in a post process, when the positive electrode terminal side metal member 38 is press-fitted into the second positive electrode terminal side mounting hole 45 so as to join the positive electrode terminal side interposing metal member 53 and the positive electrode terminal side metal member 38, and when the negative electrode terminal side metal member 39 is press-fitted into the second negative electrode terminal side mounting hole 46 so as to join the negative electrode terminal side interposing metal member 54 and the negative electrode terminal side metal member 39, mutually different kinds of metals that have the respective ionization tendencies being close together, are joined, thus an occurrence of corrosion and increase in resistance by a local battery effect can be effectively prevented.

The step of applying a press processing to a positive electrode terminal side plate member formed of the same kind of metal as a metal of the positive electrode terminal 11 so as to form the positive electrode terminal side metal member 38 that has a diameter larger than the second positive electrode terminal side mounting hole 45 is particularly carried out to apply a press processing (especially, a punching work) to the positive electrode terminal side plate member formed of aluminum or an aluminum alloy so as to form the positive electrode terminal side metal member 38 that becomes the positive electrode terminal connection part 13. The positive electrode terminal side plate member has a thickness equal to the metal plate 30, thus the positive electrode terminal side metal member 38 has a thickness equal to the metal plate 30 similarly.

The step of applying a press processing to a negative electrode terminal side plate member (not shown) formed of the same kind of metal as a metal of the negative electrode terminal 12 so as to form the negative electrode terminal side metal member 39 that has a diameter larger than the second negative electrode terminal side mounting hole 46 is particularly carried out to apply a press processing (especially, a punching work) to the negative electrode terminal side plate member formed of copper or a copper alloy so as to form the negative electrode terminal side metal member 39 that becomes the negative electrode terminal connection part 14. The negative electrode terminal side plate member has a thickness equal to the metal plate 30, thus the negative electrode terminal side metal member 39 has a thickness equal to the metal plate 30 similarly.

The step of forming the positive electrode terminal side metal member 38 and the step of forming the negative electrode terminal side metal member 39 can be also carried out at the same time.

The step of press-fitting the positive electrode terminal side metal member 38 into the inside of the second positive electrode terminal side mounting hole 45 so as to join the positive electrode terminal side interposing metal member 53 and the positive electrode terminal side metal member 38, and press-fitting the negative electrode terminal side metal member 39 into the inside of the second negative electrode terminal side mounting hole 46 so as to join the negative electrode terminal side interposing metal member 54 and the negative electrode terminal side metal member 39 is particularly carried out to press-fit the positive electrode terminal side metal member 38 in the inside of the second positive electrode terminal side mounting hole 45 and simultaneously press-fit the negative electrode terminal side metal member 39 in the inside of the second negative electrode terminal side mounting hole 46 by a blanking punch of a press device (refer to FIGS. 12E and 12F).

At this time, the positive electrode terminal side metal member 38 and the second positive electrode terminal side mounting hole 45 are brought into contact with each other so that the positive electrode terminal side metal member 38 is press-fitted into the inside of the second positive electrode terminal side mounting hole 45 while being mutually scraped in their surfaces and performing plastic deformation. As a result, even if an oxide film is slightly formed in the inner peripheral surface of the second positive electrode terminal side mounting hole 45, the oxide film is broken just before the joining, and generation of a newly formed surface is accelerated so that diffusion joining can be carried out between the metal of the positive electrode terminal side interposing metal member 53 and aluminum or the like of the positive electrode terminal side metal member 38.

Consequently, the metal of the positive electrode terminal side interposing metal member 53 and aluminum or the like of the positive electrode terminal side metal member 38 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the positive electrode terminal side interposing metal member 53 and aluminum or the like of the positive electrode terminal side metal member 38 have the respective ionization tendencies being close together, thus even if these mutually different kinds of metals are joined, in principle, corrosion and increase in resistance by a local battery effect is hard to occur.

Similarly, the negative electrode terminal side metal member 39 and the second negative electrode terminal side mounting hole 46 are brought into contact with each other so that the negative electrode terminal side metal member 39 is press-fitted into the inside of the second negative electrode terminal side mounting hole 46 while being mutually scraped in their surfaces and performing plastic deformation. As a result, even if an oxide film is slightly formed in the inner peripheral surface of the second negative electrode terminal side mounting hole 46, the oxide film is broken just before the joining, and generation of a newly formed surface is accelerated so that diffusion joining can be carried out between the metal of the negative electrode terminal side interposing metal member 54 and copper or the like of the negative electrode terminal side metal member 39.

Consequently, the metal of the negative electrode terminal side interposing metal member 54 and copper or the like of the negative electrode terminal side metal member 39 are subjected to the joining of mutually different kinds of metals, but this joining is based on the diffusion joining that metallurgically integrates two metal surfaces under the solid phase, thus the joining reliability can be enhanced and simultaneously an occurrence of corrosion and increase in resistance by a local battery effect can be prevented.

In addition, the metal of the negative electrode terminal side interposing metal member 54 and copper or the like of the negative electrode terminal side metal member 39 have the respective ionization tendencies being close together, thus even if these mutually different kinds of metals are joined, in principle, corrosion and increase in resistance by a local battery effect is hard to occur.

A press processing has a processing speed higher than the other processing method, thus the above-mentioned steps can be continuously carried out by a press device, thereby work and operation from the forming of the first positive electrode terminal side mounting hole 43 to the joining of the metal plate 30 and the positive electrode terminal side interposing metal member 53 and work and operation from the forming of the first negative electrode terminal side mounting hole 44 to the metal plate 30 and the negative electrode terminal side interposing metal member 54, and further work and operation from the forming of the second positive electrode terminal side mounting hole 45 to the joining of the positive electrode terminal side interposing metal member 53 and the positive electrode terminal side metal member 38 and work and operation from the forming of the second negative electrode terminal side mounting hole 46 to the negative electrode terminal side interposing metal member 54 and the negative electrode terminal side metal member 39 can be carried out in a short time. Consequently, in particular, even in an aluminum based oxide film formed on the surface of aluminum or an aluminum alloy, and known to be extremely stable when formed once and hard to disappear even if diffusion joining is carried out by annealing, the growth thereof can be prevented to a minimum so that joining can be carried out. In addition, even if the oxide film is slightly formed, joining by expansion is carried out, thereby generation of a newly formed surface is accelerated so that sufficient joining strength can be obtained between mutually different kinds of metals.

Further, in order to continuously carry out the respective steps by a press device, for example, a process can be adopted, the process being configured such that the respective steps are divided by each of the processing stages (base stands), and the processing stages are changed by a conveyor accompanying the progress of the steps.

After the above-mentioned steps, a press processing (especially, a punching work) is applied to the positive electrode terminal side metal member 38 and the negative electrode terminal side metal member 39 so as to form the positive electrode terminal fixing hole 17 and the negative electrode terminal fixing hole 18, so that the positive electrode terminal connection part 13 and the negative electrode terminal connection part 14 are formed (refer to FIG. 12G).

In the step, a press processing is applied to the center part of the positive electrode terminal side metal member 38 to allow the positive electrode terminal side metal member 38 to remain in the inner peripheral part of the second positive electrode terminal side mounting hole 45 so as to form the positive electrode terminal fixing hole 17, and simultaneously a press processing is applied to the center part of the negative electrode terminal side metal member 39 to allow the negative electrode terminal side metal member 39 to remain in the inner peripheral part of the second negative electrode terminal side mounting hole 46 so as to form the negative electrode terminal fixing hole 18.

Thereby, when the positive electrode terminal 11 is inserted into the positive electrode terminal fixing hole 17 so as to be fixed by resistance welding or the like, the positive electrode terminal 11 and the positive electrode terminal side metal member 38 that are mutually formed of the same kind of metal are brought into contact with each other, and when the negative electrode terminal 12 is inserted into the negative electrode terminal fixing hole 18 so as to be fixed by resistance welding or the like, the negative electrode terminal 12 and the negative electrode terminal side metal member 39 that are mutually formed of the same kind of metal are brought into contact with each other so that the joining of the mutually same kind of metal can be realized.

Further, when the positive electrode terminal fixing hole 17 and the negative electrode terminal fixing hole 18 are formed, in order to prevent the joining of mutually different kinds of metals, it is preferable that the positive electrode terminal side interposing metal member 53 and the negative electrode terminal side interposing metal member 54 are not exposed in the inner peripheral surfaces of the positive electrode terminal fixing hole 17 that comes into contact with the positive electrode terminal 11 and the negative electrode terminal fixing hole 18 that comes into contact with the negative electrode terminal 12.

In addition, it is preferable that the press-fitting type manufacturing method further includes the step of heating under an inert atmosphere after joining the positive electrode terminal side interposing metal member 53 and the positive electrode terminal side metal member 38 and joining the negative electrode terminal side interposing metal member 54 and the negative electrode terminal side metal member 39 (refer to FIG. 12H).

Thereby, diffusion joining between the metal of the metal plate 30 and the metal of the positive electrode terminal side interposing metal member 53, diffusion joining between the metal of the positive electrode terminal side interposing metal member 53 and aluminum or the like of the positive electrode terminal side metal member 38, diffusion joining between the metal of the metal plate 30 and the metal of the negative electrode terminal side interposing metal member 54 and diffusion joining between the metal of the negative electrode terminal side interposing metal member 54 and copper or the like of the negative electrode terminal side metal member 39 are sufficiently progressed so that joining strength can be further heightened.

As the inert atmosphere, a helium gas atmosphere or an argon gas atmosphere can be used. The heating temperature is controlled to a temperature not more than the melting point of the metal plate 30, the positive electrode terminal side interposing metal member 53, the negative electrode terminal side interposing metal member 54, the positive electrode terminal side metal member 38 and the negative electrode terminal side metal member 39 that are base materials.

When the nonaqueous electrolyte secondary batteries 16 are connected in series-parallel via the electrode terminal connection body 10 obtained by the above-mentioned steps, the positive electrode terminal fixing hole 17 of the electrode terminal connection body 10 and the positive electrode terminal 11 of the one nonaqueous electrolyte secondary battery 16 are fixed by resistance welding or the like, and the negative electrode terminal fixing hole 18 of the electrode terminal connection body 10 and the negative electrode terminal 12 of the other nonaqueous electrolyte secondary battery 16 are fixed by resistance welding or the like, so that the positive electrode terminal 11 and the negative electrode terminal 12 are electrically connected to each other.

At this time, the positive electrode terminal fixing hole 17 that comes into contact with the positive electrode terminal 11 is formed of the positive electrode terminal side metal member 38 that is the same kind of metal as a metal of the positive electrode terminal 11, and the negative electrode terminal fixing hole 18 that comes into contact with the negative electrode terminal 12 is formed of the negative electrode terminal side metal member 39 that is the same kind of metal as a metal of the negative electrode terminal 12, thus the joining of the mutually same kind of metal can be realized so that in principle, an occurrence of corrosion and increase in resistance by a local battery effect can be prevented.

In addition, the joining of the mutually same kind of metal is used, thus a simple technique such as a resistance welding as a technique for a joining of metals can be adopted.

Next, an operation and effect of the manufacturing method of the electrode terminal connection body of the third embodiment of the invention will be explained.

The electrode terminal connection bodies described in JP-2011-210482 A1 and JP-2012-89254 A1 are manufactured by forming an intermediate product in which mutually different kinds of metals are joined, by a hydrostatic extrusion processing, and applying to the intermediate product so as to obtain an electrode terminal connection body having a plate-like shape.

In order to carry out a hydrostatic extrusion processing, a large-scaled facility is needed, and in order to apply a cutting processing to the intermediate product so as to obtain an electrode terminal connection body having a plate-like shape, a long time is needed and simultaneously waste of chip is increased, thus it is estimated that production cost is extremely increased.

In addition, W-2011-210482 A1 discloses that an electrode terminal connection body is manufactured by forming a mounting hole in a plate material and press-fitting a metal member formed of a different kind of metal into the mounting hole, but there is a risk that before the metal member is press-fitted into the mounting hole, an oxide film is grown on the surface of aluminum or an aluminum alloy so that sufficient joining strength cannot be obtained between mutually different kinds of metals.

On the other hand, in accordance with the manufacturing method of the electrode terminal connection body according to the third embodiment, the steps from the forming of the first positive electrode terminal side mounting hole 43 and the first negative electrode terminal side mounting hole 44 to the joining of the positive electrode terminal side metal member 38 and the negative electrode terminal side metal member 39 are carried out by a press processing that is excellent in a processing speed and can be operated by a small-scaled facility in comparison with a hydrostatic extrusion processing, so that a large-scaled facility is not needed and the steps from the forming of the first positive electrode terminal side mounting hole 43 and the first negative electrode terminal side mounting hole 44 to the joining of the positive electrode terminal side metal member 38 and the negative electrode terminal side metal member 39 can be carried out in a short time.

In addition, in the manufacturing method of the electrode terminal connection body, the processing speed of the steps from the forming of the first positive electrode terminal side mounting hole 43 and the first negative electrode terminal side mounting hole 44 to the joining of the positive electrode terminal side metal member 38 and the negative electrode terminal side metal member 39 is higher than that of a case of using a hydrostatic extrusion processing and/or a cutting processing together so that the growth of oxide film can be prevented during the processing.

Furthermore, in the manufacturing method of the electrode terminal connection body, when the first positive electrode terminal side mounting hole 43 and the positive electrode terminal side interposing metal member 53 are joined, when the first negative electrode terminal side mounting hole 44 and the negative electrode terminal side interposing metal member 54 are joined, when the second positive electrode terminal side mounting hole 45 and the positive electrode terminal side metal member 38 are joined, and when the second negative electrode terminal side mounting hole 46 and the negative electrode terminal side metal member 39 are joined, even if an oxide film is slightly formed in the inner peripheral surfaces of the first positive electrode terminal side mounting hole 43, the first negative electrode terminal side mounting hole 44, the second positive electrode terminal side mounting hole 45, or the second negative electrode terminal side mounting hole 46, just before the joining, the oxide film can be broken and diffusion joining can be applied to mutually different kinds of metals so that sufficient joining strength can be obtained between mutually different kinds of metals. Namely, in accordance with the manufacturing method of the electrode terminal connection body according to the third embodiment, a large-scaled facility is not needed and the steps from the forming of the mounting hole to the joining of the metal member can be carried out in a short time, so that the electrode terminal connection body 10 can be obtained, the electrode terminal connection body 10 being capable of preventing the growth of oxide film to a minimum so as to be joined and realizing a sufficient joining strength between mutually different kinds of metals, in addition to the above, the electrode terminal connection body 10 according to the third embodiment being configured such that a main base material occupying most of the whole volume is free from limitation due to the metal of which the electrode terminal is formed and materials having various characteristics can be freely used as the main base material, and being capable of preventing an occurrence of corrosion and increase in resistance in the joining part thereof.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

The third embodiment is configured such that in the expansion type manufacturing method, all of the joinings are carried out by the expansion, and in the press-fitting type manufacturing method, all of the joinings are carried out by the press-fitting, but not limited to this, a combination of the joining by the expansion and the joining by the press-fitting may be also adopted.

As mentioned above, according to the third embodiment of the invention, an electrode terminal connection body and a manufacturing method of the electrode terminal connection body can be provided, the electrode terminal connection body being configured such that a main base material occupying most of the whole volume is free from limitation due to the metal of which the electrode terminal is formed, and materials having various characteristics can be freely used as the main base material, and being capable of preventing an occurrence of corrosion and increase in resistance in the joining part thereof.

What is claimed is:

1. An electrode terminal connection body, configured to electrically connect a positive electrode terminal and a negative electrode terminal that are formed of mutually different kinds of metals, comprising:
a positive electrode terminal connection part formed of the same kind of metal as a metal of the positive electrode terminal; and
a negative electrode terminal connection part formed of the same kind of metal as a metal of the negative electrode terminal,
wherein the positive electrode terminal connection part and the negative electrode terminal connection part are connected via an interposing part formed of a metal that has an ionization tendency between the metal of the positive electrode terminal and the metal of the negative electrode terminal.

2. A manufacturing method for an electrode terminal connection body configured to electrically connect a positive electrode terminal and a negative electrode terminal that are formed of mutually different kinds of metals, comprising:
applying a press processing to a thin plate formed of the same kind of metal as a metal of the positive electrode terminal so as to form a first mounting hole;
applying a press processing to a first thick plate formed of a metal that has an ionization tendency between the metal of the positive electrode terminal and the metal of the negative electrode terminal so as to form a first metal member that has a diameter smaller than the first mounting hole;
inserting the first metal member into the inside of the first mounting hole and simultaneously crushing the first metal member in the inside of the first mounting hole so as to join the thin plate and the first metal member while expanding the first mounting hole;
applying a press processing to the center part of the first metal member to allow the first metal member to remain in the inner peripheral part of the first mounting hole so as to form a second mounting hole;
applying a press processing to a second thick plate formed of the same kind of metal as a metal of the negative electrode terminal so as to form a second metal member that has a diameter smaller than the second mounting hole; and
inserting the second metal member into the inside of the second mounting hole and simultaneously crushing the second metal member in the inside of the second mounting hole so as to join the first metal member and the second metal member while expanding the second mounting hole.

3. The manufacturing method for an electrode terminal connection body according to claim 2, further comprising:
applying a press processing to the thin plate so as to form a positive electrode terminal fixing hole; and
applying a press processing to the center part of the second metal member to allow the second metal member to remain in the inner peripheral part of the second mounting hole so as to form a negative electrode terminal fixing hole.

4. A manufacturing method for an electrode terminal connection body configured to electrically connect a positive electrode terminal and a negative electrode terminal that are formed of mutually different kinds of metal, comprising:
applying a negative electrode terminal connection part to a thin plate formed of the same kind of metal as a metal of the negative electrode terminal so as to form a first mounting hole;
applying a press processing to a first thick plate formed of a metal that has an ionization tendency between the metal of the positive electrode terminal and the metal of the negative electrode terminal so as to form a first metal member that has a diameter smaller than the first mounting hole;
inserting the first metal member into the inside of the first mounting hole and simultaneously crushing the first metal member in the inside of the first mounting hole so as to join the thin plate and the first metal member while expanding the first mounting hole;
applying a press processing to the center part of the first metal member to allow the first metal member to remain in the inner peripheral part of the first mounting hole so as to form a second mounting hole;
applying a press processing to a second thick plate formed of the same kind of metal as a metal of the positive electrode terminal so as to form a second metal member that has a diameter smaller than the second mounting hole; and
inserting the second metal member into the inside of the second mounting hole and simultaneously crushing the second metal member in the inside of the second mounting hole so as to join the first metal member and the second metal member while expanding the second mounting hole.

5. The manufacturing method for an electrode terminal connection body according to claim 4, further comprising:
applying a press processing to the thin plate so as to form a negative electrode terminal fixing hole; and
applying a press processing to the center part of the second metal member to allow the second metal member to remain in the inner peripheral part of the second mounting hole so as to form a positive electrode terminal fixing hole.

6. A manufacturing method for an electrode terminal connection body configured to electrically connect a positive electrode terminal and a negative electrode terminal that are formed of mutually different kinds of metal, comprising:
applying a press processing to a first plate member formed of the same kind of metal as a metal of the positive electrode terminal so as to form a first mounting hole;
applying a press processing to a second plate member formed of a metal that has an ionization tendency between the metal of the positive electrode terminal and the metal of the negative electrode terminal so as to form a first metal member that has a diameter larger than the first mounting hole;
press-fitting the first metal member into the inside of the first mounting hole so as to join the first plate member and the first metal member;
applying a press processing to the center part of the first metal member to allow the first metal member to remain in the inner peripheral part of the first mounting hole so as to form a second mounting hole;
applying a press processing to a third plate member formed of the same kind of metal as a metal of the negative electrode terminal so as to form a second metal member that has a diameter larger than the second mounting hole; and
press-fitting the second metal member into the inside of the second mounting hole so as to join the first metal member and the second metal member.

7. The manufacturing method for an electrode terminal connection body according to claim 6, further comprising:
applying a press processing to the first plate member so as to form a positive electrode terminal fixing hole; and
applying a press processing to the center part of the second metal member to allow the second metal member to remain in the inner peripheral part of the second mounting hole so as to form a negative electrode terminal fixing hole.

8. A manufacturing method for an electrode terminal connection body configured to electrically connect a positive electrode terminal and a negative electrode terminal that are formed of mutually different kinds of metal, comprising:
applying a press processing to a first plate member formed of the same kind of metal as a metal of the negative electrode terminal so as to form a first mounting hole;
applying a press processing to a second plate member formed of a metal that has an ionization tendency between the metal of the positive electrode terminal and the metal of the negative electrode terminal so as to form a first metal member that has a diameter larger than the first mounting hole;
press-fitting the first metal member into the inside of the first mounting hole so as to join the first plate member and the first metal member;
applying a press processing to the center part of the first metal member to allow the first metal member to remain in the inner peripheral part of the first mounting hole so as to form a second mounting hole;
applying a press processing to a third plate member formed of the same kind of metal as a metal of the positive electrode terminal so as to form a second metal member that has a diameter larger than the second mounting hole; and
press-fitting the second metal member into the inside of the second mounting hole so as to join the first metal member and the second metal member.

9. The manufacturing method for an electrode terminal connection body according to claim 8, further comprising:
applying a press processing to the first plate member so as to form a negative electrode terminal fixing hole; and
applying a press processing to the center part of the second metal member to allow the second metal member to remain in the inner peripheral part of the second mounting hole so as to form a positive electrode terminal fixing hole.

10. The manufacturing method for an electrode terminal connection body according to claim 2, further comprising:
heating under an inert atmosphere after joining the first metal member and the second metal member.

11. An electrode terminal connection body configured to electrically connect a positive electrode terminal and a negative electrode terminal that are formed of mutually different kinds of metals, comprising:
a metal plate;
a positive electrode terminal connection part disposed in a part of the metal plate and formed of the same kind of metal as a metal of the positive electrode terminal; and
a negative electrode terminal connection part disposed in a part of the metal plate and formed of the same kind of metal as a metal of the negative electrode terminal.

12. The electrode terminal connection body according to claim 11, wherein the metal plate comprises an aluminum based material or a copper based material.

13. A manufacturing method for an electrode terminal connection body configured to electrically connect a positive electrode terminal and a negative electrode terminal that are formed of mutually different kinds of metals, comprising:
applying a press processing to a metal plate so as to form a positive electrode terminal side mounting hole and a negative electrode terminal side mounting hole;
applying a press processing to a positive electrode terminal side thick plate formed of the same kind of metal as a metal of the positive electrode terminal so as to form a positive electrode terminal side metal member that has a diameter smaller than the positive electrode terminal side mounting hole;
applying a press processing to a negative electrode terminal side thick plate formed of the same kind of metal as a metal of the negative electrode terminal so as to form a negative electrode terminal side metal member that has a diameter smaller than the negative electrode terminal side mounting hole; and
inserting the positive electrode terminal side metal member into the inside of the positive electrode terminal side mounting hole and simultaneously crushing the positive electrode terminal side metal member in the inside of the positive electrode terminal side mounting hole so as to join the metal plate and the positive electrode terminal side metal member while expanding the positive electrode terminal side mounting hole, and inserting the negative electrode terminal side metal member into the inside of the negative electrode terminal side mounting hole and simultaneously crushing the negative electrode terminal side metal member in the inside of the negative electrode terminal side mounting hole so as to join the metal plate and the negative electrode terminal side metal member while expanding the negative electrode terminal side mounting hole.

14. A manufacturing method for an electrode terminal connection body configured to electrically connect a positive electrode terminal and a negative electrode terminal that are formed of mutually different kinds of metals, comprising:
applying a press processing to a metal plate so as to form a positive electrode terminal side mounting hole and a negative electrode terminal side mounting hole;
applying a press processing to a positive electrode terminal side plate member formed of the same kind of metal as a metal of the positive electrode terminal so as to form a positive electrode terminal side metal member that has a diameter larger than the positive electrode terminal side mounting hole;
applying a press processing to a negative electrode terminal side plate member formed of the same kind of metal as a metal of the negative electrode terminal so as to form a negative electrode terminal side metal member that has a diameter larger than the negative electrode terminal side mounting hole; and
press-fitting the positive electrode terminal side metal member into the inside of the positive electrode terminal side mounting hole so as to join the metal plate and the positive electrode terminal side metal member, and press-fitting the negative electrode terminal side metal member into the inside of the negative electrode terminal side mounting hole so as to join the metal plate and the negative electrode terminal side metal member.

15. The manufacturing method for an electrode terminal connection body according to claim 13, wherein the metal plate comprises an aluminum based material or a copper based material.

16. The manufacturing method for an electrode terminal connection body according to claim 13, further comprising:
applying a press processing to the center part of the positive electrode terminal side metal member to allow the positive electrode terminal side metal member to remain in the inner peripheral part of the positive electrode terminal side mounting hole so as to form a positive electrode terminal fixing hole; and
applying a press processing to the center part of the negative electrode terminal side metal member to allow the negative electrode terminal side metal member to remain in the inner peripheral part of the negative electrode terminal side mounting hole so as to form a negative electrode terminal fixing hole.

17. The manufacturing method for an electrode terminal connection body according to claim 13, further comprising:
heating under an inert atmosphere after joining the metal plate and the positive electrode terminal side metal member, and joining the metal plate and the negative electrode terminal side metal member.

18. An electrode terminal connection body configured to electrically connect a positive electrode terminal and a negative electrode terminal that are formed of mutually different kinds of metals, comprising:
a metal plate;
a positive electrode terminal connection part disposed in a part of the metal plate and formed of the same kind of metal as a metal of the positive electrode terminal; and
a negative electrode terminal connection part disposed in a part of the metal plate and formed of the same kind of metal as a metal of the negative electrode terminal,
wherein the positive electrode terminal connection part and the metal plate are connected via a positive electrode terminal side interposing part formed of a metal that has an ionization tendency between the metal of the positive electrode terminal and the metal of the metal plate, and the negative electrode terminal connection part and the metal plate are connected via a negative electrode terminal side interposing part formed of a metal that has an ionization tendency between the metal of the negative electrode terminal and the metal of the metal plate.

19. The electrode terminal connection body according to claim 18, wherein the metal plate comprises an aluminum based material or a copper based material.

20. A manufacturing method for an electrode terminal connection body configured to electrically connect a positive electrode terminal and a negative electrode terminal that are formed of mutually different kinds of metals, comprising:
applying a press processing to a metal plate so as to form a first positive electrode terminal side mounting hole and a first negative electrode terminal side mounting hole;
applying a press processing to a positive electrode terminal side interposing thick plate formed of a metal that has an ionization tendency between the metal of the positive electrode terminal and the metal of the metal plate so as to form a positive electrode terminal side interposing metal member that has a diameter smaller than the first positive electrode terminal side mounting hole;
applying a press processing to a negative electrode terminal side interposing thick plate formed of a metal that has an ionization tendency between the metal of the negative electrode terminal and the metal of the metal plate so as to form a negative electrode terminal side interposing metal member that has a diameter smaller than the first negative electrode terminal side mounting hole;
inserting the positive electrode terminal side interposing metal member into the inside of the first positive electrode terminal side mounting hole and simultaneously crushing the positive electrode terminal side imposing metal member in the inside of the first positive electrode terminal side mounting hole so as to join the metal plate and the positive electrode terminal side interposing metal member while expanding the first positive electrode terminal side mounting hole, and inserting the negative electrode terminal side interposing metal member into the inside of the first negative electrode terminal side mounting hole and simultaneously crushing the negative electrode terminal side imposing metal member in the inside of the first negative electrode terminal side mounting hole so as to join the metal plate and the negative electrode terminal side interposing metal member while expanding the first negative electrode terminal side mounting hole;
applying a press processing to the center part of the positive electrode terminal side interposing metal member to allow the positive electrode terminal side interposing metal member to remain in the inner peripheral part of the first positive electrode terminal side mounting hole so as to form a second positive electrode terminal mounting hole, and applying a press processing to the center part of the negative electrode terminal side interposing metal member to allow the negative electrode terminal side interposing metal member to remain in the inner peripheral part of the first negative electrode terminal side mounting hole so as to form a second negative electrode terminal mounting hole;
applying a press processing to a positive electrode terminal side thick plate formed of the same kind of metal as a metal of the positive electrode terminal so as to form a positive electrode terminal side metal member that has a diameter smaller than the second positive electrode terminal side mounting hole;
applying a press processing to a negative electrode terminal side thick plate formed of the same kind of metal as a metal of the negative electrode terminal so as to form a negative electrode terminal side metal member that has a diameter smaller than the second negative electrode terminal side mounting hole; and
inserting the positive electrode terminal side metal member into the inside of the second positive electrode terminal side mounting hole and simultaneously crushing the positive electrode terminal side metal member in the inside of the second positive electrode terminal side mounting hole so as to join the positive electrode terminal side interposing metal member and the positive electrode terminal side metal member while expanding the second positive electrode terminal side mounting hole, and inserting the negative electrode terminal side metal member into the second inside of the negative electrode terminal side mounting hole and simultaneously crushing the negative electrode terminal side metal member in the inside of the second negative electrode terminal side mounting hole so as to join the negative electrode terminal side interposing metal member and the negative electrode terminal side metal member while expanding the second negative electrode terminal side mounting hole.

21. A manufacturing method for an electrode terminal connection body configured to electrically connect a positive electrode terminal and a negative electrode terminal that are formed of mutually different kinds of metals, comprising:
applying a press processing to a metal plate so as to form a first positive electrode terminal side mounting hole and a first negative electrode terminal side mounting hole;
applying a press processing to a positive electrode terminal side interposing plate member formed of a metal that has an ionization tendency between the metal of the positive electrode terminal and the metal of the metal plate so as to form a positive electrode terminal side interposing metal member that has a diameter larger than the first positive electrode terminal side mounting hole;
applying a press processing to a negative electrode terminal side interposing plate member formed of a metal that has an ionization tendency between the metal of the negative electrode terminal and the metal of the metal plate so as to form a negative electrode terminal side interposing metal member that has a diameter larger than the first negative electrode terminal side mounting hole;
press-fitting the positive electrode terminal side interposing metal member into the inside of the first positive electrode terminal side mounting hole so as to join the metal plate and the positive electrode terminal side interposing metal member, and press-fitting the negative electrode terminal side interposing metal member into the inside of the first negative electrode terminal side mounting hole so as to join the metal plate and the negative electrode terminal side interposing metal member;
applying a press processing to the center part of the positive electrode terminal side interposing metal member to allow the positive electrode terminal side interposing metal member to remain in the inner peripheral part of the first positive electrode terminal side mounting hole so as to form a second positive electrode terminal mounting hole, and applying a press processing to the center part of the negative electrode terminal side interposing metal member to allow the negative electrode terminal side interposing metal member to remain in the inner peripheral part of the first negative electrode terminal side mounting hole so as to form a second negative electrode terminal mounting hole;
applying a press processing to a positive electrode terminal side plate member formed of the same kind of metal as a metal of the positive electrode terminal so as to form a positive electrode terminal side metal member that has a diameter larger than the second positive electrode terminal side mounting hole;
applying a press processing to a negative electrode terminal side plate member formed of the same kind of metal as a metal of the negative electrode terminal so as to form a negative electrode terminal side metal member that has a diameter larger than the second negative electrode terminal side mounting hole; and
press-fitting the positive electrode terminal side metal member into the inside of the second positive electrode terminal side mounting hole so as to join the positive electrode terminal side interposing metal member and the positive electrode terminal side metal member, and press-fitting the negative electrode terminal side metal member into the inside of the second negative electrode terminal side mounting hole so as to join the negative electrode terminal side interposing metal member and the negative electrode terminal side metal member.

22. The manufacturing method for an electrode terminal connection body according to claim 20, wherein the metal plate comprises an aluminum based material or a copper based material.

23. The manufacturing method for an electrode terminal connection body according to claim 20, further comprising:
applying a press processing to the center part of the positive electrode terminal side metal member to allow the positive electrode terminal side metal member to remain in the inner peripheral part of the second positive electrode terminal side mounting hole so as to form a positive electrode terminal fixing hole; and
applying a press processing to the center part of the negative electrode terminal side metal member to allow the negative electrode terminal side metal member to remain in the inner peripheral part of the second negative electrode terminal side mounting hole so as to form a negative electrode terminal fixing hole.

24. The manufacturing method for an electrode terminal connection body according to claim 20, further comprising:
heating under an inert atmosphere after joining the positive electrode terminal side interposing metal member and the positive electrode terminal side metal member, and joining the negative electrode terminal side interposing metal member and the negative electrode terminal side metal member.
